(19) United States
(12) Patent Application Publication
(10) Pub. No.: US 2017/0230464 A1
(43) Pub. Date: Aug. 10, 2017

(54) INFORMATION PROCESSING SYSTEM, INFORMATION PROCESSING APPARATUS, AND SERVICE DEPLOYMENT METHOD

(71) Applicant: FUJITSU LIMITED, Kawasaki-shi (JP)

(72) Inventors: Hideto KIHARA, Kawasaki (JP); Naoki Nishiguchi, Kawasaki (JP); Takashi Ohno, Kobe (JP)

(73) Assignee: FUJITSU LIMITED, Kawasaki-shi (JP)

(21) Appl. No.: 15/421,369

(22) Filed: Jan. 31, 2017

(30) Foreign Application Priority Data
Feb. 4, 2016 (JP) 2016-020169

(51) Int. Cl. H04L 29/08

(52) U.S. Cl. CPC H04L 67/141; H04L 67/34; H04L 67/42

(57) ABSTRACT

When a place server accepts an access request from a terminal device, the place server notifies a management server of a status of the terminal device. The management server delivers a program of an application and a program of a service that is used by the application that are in accordance with the status notified from the place server. The place server sends the delivered program of the application to the terminal device. The place server provides the service due to the program of the service.

### CROSS-REFERENCE TO RELATED APPLICATION

This application is based upon and claims the benefit of priority of the prior Japanese Patent Application No. 2016-020169, filed on Feb. 4, 2016, the entire contents of which are incorporated herein by reference.

### FIELD

The embodiments discussed herein are related to an information processing system, an information processing apparatus, a service deployment method, and a computer-readable recording medium.

### BACKGROUND

In recent years, a large number of applications that utilize the World Wide Web (Web) technology have been introduced. For example, some applications running on a terminal device implement the function by using a service provided by a server.

Furthermore, there is a technology in which a server delivers content in accordance with a status of a terminal device. For example, the terminal device writes type information on a running application to an acquisition request for the content and sends the request to the server. The server sends the content to the terminal device on the basis of the type information on the application that is written to the acquisition request.

Patent Document 1: International Publication Pamphlet No. WO 2012/033110

Patent Document 2: Japanese Laid-open Patent Publication No. 2006-163780

Patent Document 3: Japanese Laid-open Patent Publication No. 2013-3598

However, in the terminal device, applications or services to be used may sometimes differ depending on the status, such as the location to be used. For example, in a classroom at a school, an application or a service that controls a projector arranged in a classroom may sometimes be used. Furthermore, in a conference room, an application or a service that shares data on a document may sometimes be used.

Thus, for example, it is conceivable that servers are placed at the site in which each of the applications are used and then the server delivers an application that is in accordance with the arrangement location to the terminal device. It is conceivable that the server used here is, for example, a small-sized personal computer (PC) that has a function of an access point of a wireless local area network (LAN).

In this way, if servers are arranged at the location in which each of the applications is used, an administrator sets up applications or programs of the services with respect to each of the servers in accordance with the arrangement location of each of the servers. However, because the applications or the services to be set up for each server differ, the set-up work of the servers becomes complicated.

In contrast, it is conceivable of using a method that sets up programs of all of the services into the servers. However, in the method of setting up the programs of all of the services into the servers, the storage of the servers and the resources in the memory or the like are pressed and may sometimes be insufficient.

### SUMMARY

According to an aspect of an embodiment, an information processing system includes a first server device and a second server device. The first server device includes a storage unit that stores therein a first program that is a program of an application that is used in a terminal device and a second program that is a program of a service that is used by the application, and a delivery unit that delivers the first program and the second program that are in accordance with a status notified from the second server device. The second server device includes an accepting unit that accepts an access request from the terminal device, an acquiring unit that notifies, in accordance with the access request accepted by the accepting unit, the first server device of the status of the terminal device and that acquires the first program and the second program, a sending unit that sends the first program acquired by the acquiring unit to the terminal device, and a providing unit that provides the service due to the second program acquired by the acquiring unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating, in outline, the configuration of a system according to a first embodiment;

FIG. 2 is a schematic diagram illustrating, in outline, the configuration of a management server according to the first embodiment;

FIG. 3 is a schematic diagram illustrating an example of the data structure of delivery definition information;

FIG. 4 is a schematic diagram illustrating, in outline, the configuration of a place server according to the first embodiment;

FIG. 5 is a schematic diagram illustrating an example of the data structure of delivery information;

FIG. 6 is a schematic diagram illustrating, in outline, the flow of a process of deploying a service performed by the system according to the first embodiment;

FIG. 7 is a schematic diagram illustrating an example of a change in data stored in the delivery information;

FIG. 8 is a flowchart illustrating an example of the flow of a control process performed by the place server;

FIG. 9 is a flowchart illustrating an example of the flow of the control process performed by the management server;

FIG. 10 is a schematic diagram illustrating, in outline, an example of the flow of a process of deploying a service performed by a system according to a second embodiment;

FIG. 11 is a flowchart illustrating an example of the flow of a control process performed by a place server;

FIG. 12 is a schematic diagram illustrating, in outline, the configuration of a management server according to a third embodiment;

FIG. 13 is a schematic diagram illustrating an example of the data structure of delivery definition information according to the third embodiment;

FIG. 14 is a schematic diagram illustrating an example of the data structure of status type information;

FIG. 15 is a schematic diagram illustrating, in outline, the configuration of a place server according to the third embodiment;

FIG. 16 is a schematic diagram illustrating an example of the data structure of delivery information according to the third embodiment;

FIG. 17 is a schematic diagram illustrating, in outline, an example of the flow of a process of deploying a service performed by a system according to the third embodiment;

FIG. 18 is a flowchart illustrating an example of the flow of a control process performed by a place server;

FIG. 19 is a flowchart illustrating an example of the flow of a use condition determination process performed by the place server;

FIG. 20 is a flowchart illustrating an example of the flow of an operating condition determination process performed by the place server; and

FIG. 21 is a block diagram illustrating a computer that executes a service deployment program.

### DESCRIPTION OF EMBODIMENTS

Preferred embodiments of the present invention will be explained with reference to accompanying drawings. The present invention is not limited to the embodiments. Furthermore, the embodiments can be used in any appropriate combination as long as the processes do not conflict with each other.

### [a] First Embodiment

System Configuration

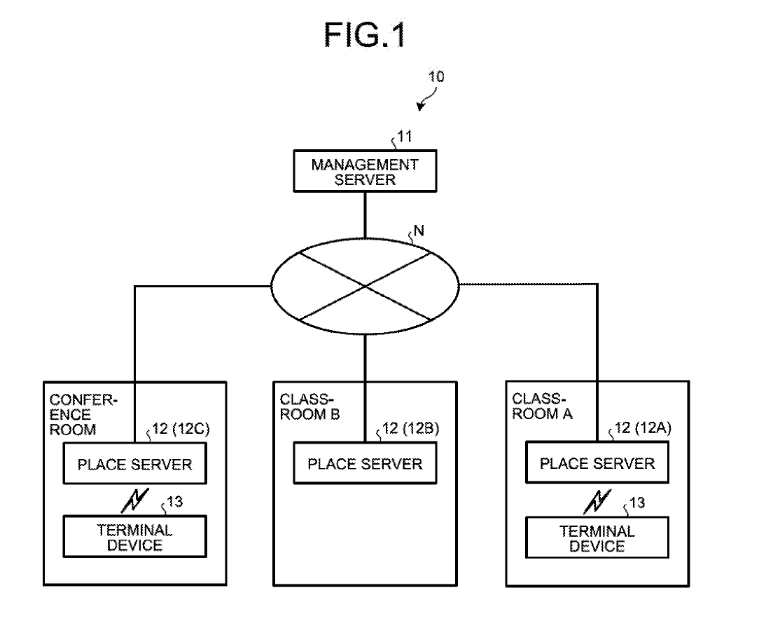

First, an example of a system 10 according to a first embodiment will be described. FIG. 1 is a schematic diagram illustrating, in outline, the configuration of a system according to a first embodiment. The system 10 is a system in which a service is deployed in accordance with a status. The system 10 corresponds to an information processing system. Furthermore, in the following, a description will be given of a case, as an example, in which the system 10 is used at the educational interface, such as a school, or the like.

As illustrated in FIG. 1, the system 10 includes a management server 11, place servers 12, and terminal devices 13. The management server 11 and the place servers 12 are connected to a network N such that the servers and the devices can perform communication with each other. Any kind of communication network, such as a LAN, a virtual private network (VPN), or the like, may be used as the network N irrespective of whether the network is a wired or wireless connection. Furthermore, in the example illustrated in FIG. 1, a case in which three place servers 12 are provided has been illustrated; however, the configuration is not limited to this and an arbitrary number of the place servers 12 may also be used. Furthermore, in the example illustrated in FIG. 1, a case in which two terminal devices 13 are provided has been illustrated; however, the configuration is not limited to this and an arbitrary number of the terminal devices 13 may also be used.

The management server 11 is a device that manages an application that is used by the terminal device 13. The management server 11 is, for example, a computer, such as a personal computer, a server computer, or the like. The management server 11 corresponds to a first server device. The management server 11 may also be implemented as a single computer or may also be implemented as a plurality number of computers. Furthermore, in the embodiment, a description will be given of a case in which the management server 11 is used as a single computer.

The management server 11 stores therein a program of an application that is used by the terminal device 13 and a program of a service that is used by the application. The program of the application that is used by the terminal device 13 corresponds to a first program. The program of the service that is used by the application corresponds to a second program. Here, the application or the service used by the terminal device 13 may sometimes differ in accordance with the status, such as the location to be used. For example, in a classroom at school, an application or a service that controls a projector arranged in a classroom may sometimes be used. Furthermore, in a conference room, an application or a service that shares data on a document may sometimes be used. In the embodiment, the name representing the status is allocated to the status, such as the location or the like, in which the application or the service is used and the name of the status is referred to as a virtual place. The management server 11 delivers, to the place server 12, the program of the application and the program of the service that are in accordance with the status notified by the place server 12.

The place server 12 executes the program delivered from the management server 11 and provides the service that is used by the application. The place server 12 corresponds to a second server device. The place server 12 is arranged at the location in which the application stored in the management server 11 is used. In the embodiment, a place server 12A is arranged in a classroom A, a place server 12B is arranged in a classroom B, and a place server 12C is arranged in a conference room. The place server 12 is, for example, an information processing apparatus, such as a small-sized PC or the like, that has a function of an access point of wireless communication, such as a wireless LAN or the like. Furthermore, the place server 12 may also be configured by being divided into an access point of a wireless LAN and a small-sized PC. Furthermore, the place server 12 may also be a portable information processing apparatus, such as a tablet terminal or the like, that has a wireless communication function.

The place server 12 can perform communication with the terminal device 13 by using wireless communication and accepts an access request from the terminal device 13. When the place server 12 accepts the access request from the terminal device 13, the place server 12 notifies the management server 11 of the status of the terminal device 13 or the place server 12 from which the access request has been accepted. For example, the place server 12 accepts an access request including the status of the terminal device 13 from the subject terminal device 13. The place server 12 notifies the management server 11 of the status included in the access request. Consequently, the management server 11 delivers, to the place server 12, the program of the application and the program of the service that are in accordance with the notified status.

The place server 12 sends the program of the application delivered from the management server 11 to the terminal device 13. Furthermore, the place server 12 executes the program of the service delivered from the management server 11 and provides the service.

The terminal device 13 is a device that is used by a user, such as a teacher, a student, or the like of a school, who uses the application. For example, the terminal device 13 is a portable information processing apparatus, such as a smart phone, a tablet terminal, or the like, that is used by the user. The terminal device 13 sends an access request to the place server 12. For example, in the terminal device 13, a control application for a terminal that controls deployment of the service is installed and is running. If wireless communication with the place server 12 becomes available, the control application sends a check-in request including the status of the terminal device 13, such as the current location of the terminal device 13. Furthermore, if the wireless communication with the place server 12 becomes unavailable, the control application sends a check-out request. For example, the control application sends a check-in request at the first timing in which the signal level of the wireless communication from the place server 12 exceeds a predetermined value. Furthermore, the control application sends a check-out request at the first timing in which the signal level of the wireless communication from the place server 12 becomes equal to or less than the predetermined value.

The terminal device 13 may also create information related to the status by using an internal process. Furthermore, the terminal device 13 may also receive the information related to the status from another device. Furthermore, the terminal device 13 may also allow a user to input the information related to the status. Furthermore, in the terminal device 13, the information related to the status may also previously be set. For example, the terminal device 13 may also be arranged in each of the locations and may also acquire the status from a status notification device that delivers the status by using wireless communication. For example, the status notification device arranged in the classroom A delivers the information, as the status, indicating that the location is the classroom A by using wireless communication. The terminal device 13 that enters the classroom A may also acquire the information indicating the location from the status notification device that is arranged in the classroom A. Furthermore, the terminal device 13 may also display a selection screen on which the location is selected and may also acquire the status related to the location selected by a user. Furthermore, for example, status notification device arranged in the classroom A delivers, as the status by using wireless communication at the time of each lesson in accordance with the timetable of the lesson performed in the classroom A, the information indicating the lesson that is being operated. The terminal device 13 that enters the classroom A may also acquire the status related to the lesson by receiving, from the status notification device that is arranged in the classroom A, the information indicating the lesson that is being given. Furthermore, the terminal device 13 may also acquire the status related to the lesson by displaying the selection screen that is used to select the lesson and by allowing a user to select the lesson. Furthermore, for example, when the type of a user, such as a student or a teacher, is set as the status of the terminal device 13, the terminal device 13 may also display a selection screen that is used to select the type of the user and may also acquire the status related to the user by allowing the user to select the type of the user. Furthermore, the control application may also be divided into each type of users, such as users for students, users for teachers, or the like, and the type of users may also previously be set in the control application.

When the place server 12 receives an access request including the status from the terminal device 13, the place server 12 acquires, from the management server 11, the program of the application and the program of the service that are in accordance with the status. The place server 12 sends the acquired program of the application to the terminal device 13 that is the access request source.

Consequently, the system 10 can deliver, in accordance with the status of the terminal device 13, the available application to the terminal device 13. Furthermore, the system 10 can appropriately deploy the service that is to be used by the application in the terminal device 13 to the place server 12.

Furthermore, in the following, a description will be given of a case, as an example, in which the place server 12 notifies the management server 11 of the status of the terminal device 13 notified from the terminal device 13; however, the configuration is not limited to this. For example, the place server 12 may also notify the management server 11 of the status of the place server 12. The place server 12 may also create the information related to the status by using an internal process. Furthermore, the place server 12 may also receive the information related to the status from another device other than the terminal device 13. Furthermore, the place server 12 may also allow a user to input the information related to the status. Furthermore, in the place server 12, the information related to the status may also previously be set. For example, the place server 12 is arranged at each of the locations and may also acquire the status, such as the arrangement location or the like, from the status notification device that delivers the status by using wireless communication.

Configuration of the Management Server

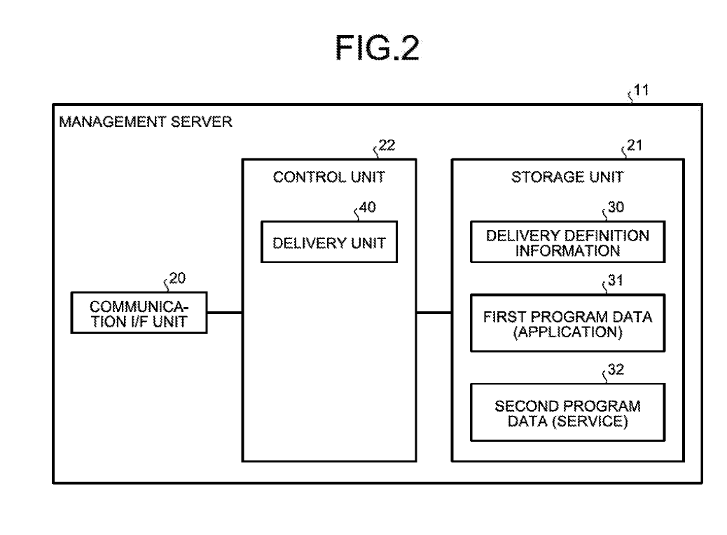

In the following, the configuration of the management server 11 according to the first embodiment will be described. FIG. 2 is a schematic diagram illustrating, in outline, the configuration of a management server according to the first embodiment. The management server 11 includes a communication interface (I/F) unit 20, a storage unit 21, and a control unit 22.

The communication I/F unit 20 is an interface that performs communication control between other devices. The communication I/F unit 20 sends and receives various kinds of information to and from the other devices via the network N. For example, the communication I/F unit 20 sends and receives various kinds of information to and from each of the place servers 12 via the network N. A network interface card, such as a LAN card or the like, can be used as the communication I/F unit 20.

The storage unit 21 is a storage device, such as a hard disk, a solid state drive (SSD), an optical disk, or the like. Furthermore, the storage unit 21 may also be a semiconductor memory, such as a RAM (random access memory), a flash memory, a non-volatile static random access memory (NVSRAM), or the like, that can rewrite data.

The storage unit 21 stores therein an operating system (OS) or various kinds of programs executed by the control unit 22. Furthermore, the storage unit 21 stores therein various kinds of data that are used in the program executed by the control unit 22. For example, the storage unit 21 stores therein delivery definition information 30, first program data 31, and second program data 32.

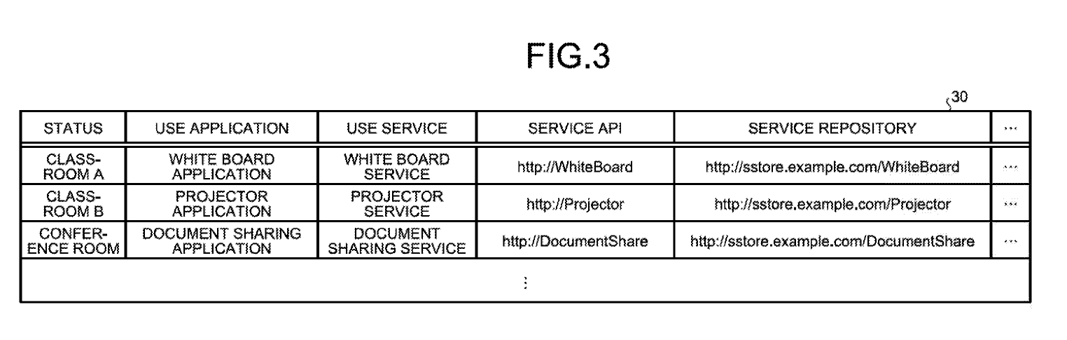

The delivery definition information 30 is data that stores therein information related to the application or the service delivered in accordance with the status. FIG. 3 is a schematic diagram illustrating an example of the data structure of delivery definition information. As illustrated in FIG. 3, the delivery definition information 30 includes items, such as the “status”, the “use application”, the “use service”, the “service API”, the “service repository”, and the like. Each of the items of the delivery definition information 30 illustrated in FIG. 3 is an example and another item may also be included. Furthermore, the data structure of the delivery definition information 30 is also an example and is not limited to this.

The item of the status is an area that stores therein the status in which the application and the service are used. In the embodiment, in order to easily identify the status related to the location in which the application and the service are used, a virtual place of the status is used as the name that represents the status; however, a code or the like may also be used. The item of the use application is an area in which the name of the application that is used in the status indicated by the item of the status. The item of the use service is an area that stores therein the name of the service that is used in the status indicated by the item of the status. The item of the service API is an area that stores therein definition information that accepts call to a service. In the embodiment, an application programming interface (API) that accepts call to the service is used as the definition information that accepts call to a service. The item of the service API stores therein the definition information on the API that accepts call to the service. The item of the service repository is an area that stores therein the repository location of the program of the service.

In the example illustrated in FIG. 3, the “classroom A” indicates that a “white board application” and a “white board service” can be used. Furthermore, the “white board service” indicates that the API that accepts call to the service is http://WhiteBoard and the repository location of the program of the service is “http://sstore.example.com/WhiteBoard”. Furthermore, the “classroom B” indicates that a “projector application” and a “projector service” can be used. Furthermore, the “projector service” indicates that the API that accepts call to the service is “http://Projector” and the repository location of the program of the service is “http://sstore.example.com/Projector”. Furthermore, the “conference room” indicates that the “document sharing application” and the “document sharing service” can be used. Furthermore, the “document sharing service” indicates that the API that accepts call to the service is “http://DocumentShare” and the repository location of the program of the service is “http://sstore.example.com/DocumentShare”.

A description will be given here by referring back to FIG. 2. The first program data 31 is the data that stores therein a program of an application. The second program data 32 is data that stores therein a program of a service.

The control unit 22 is a device that controls the management server 11. As the control unit 22, an electronic circuit, such as a central processing unit (CPU), a micro processing unit (MPU), and the like, or an integrated circuit, such as an application specific integrated circuit (ASIC), a field programmable gate array (FPGA), and the like, may be used. The control unit 22 includes an internal memory that stores therein control data and programs in which various kinds of procedures are prescribed, whereby the control unit 22 performs various kinds of processes. The control unit 22 functions as various kinds of processing units by various kinds of programs being operated. For example, the control unit 22 includes a delivery unit 40.

The delivery unit 40 delivers various kinds of data. For example, if the delivery unit 40 receives a notification of the status from the place server 12, the delivery unit 40 delivers the program of the application and the program of the service that is used by the subject application that are in accordance with the notified status. Here, in the embodiment, the delivery unit 40 delivers, in a different timing, the program of the application and the program of the service that is used by the subject application. For example, if the delivery unit 40 receives a notification of the status from the place server 12, the delivery unit 40 delivers the program of the application and definition information of the service that is used by the subject application that are in accordance with the notified status. For example, the delivery unit 40 reads the record that is in accordance with the notified status from the delivery definition information 30 and specifies the application, the definition information on the API that accepts call to the service used by the application, and the repository location of the program of the service that are in accordance with the notified status. The delivery unit 40 reads the program of the specified application from the first program data 31. The delivery unit 40 delivers the read program of the application, the definition information on the API that accepts call to the service, and the repository location of the program of the service to the place server 12. Furthermore, if the delivery unit 40 is requested for a program of a service from the place server 12, the delivery unit 40 delivers the program of the service that is in accordance with the request. The delivery unit 40 reads the requested program of the service from the second program data 32. The delivery unit 40 delivers the read program of the service to the place server 12 that is the request source. Namely, in the embodiment, the delivery unit 40 delivers the program of the application and the definition information on the API that accepts call to the service first and then delivers the program of the service that is used by the subject application.

Configuration of the Place Server

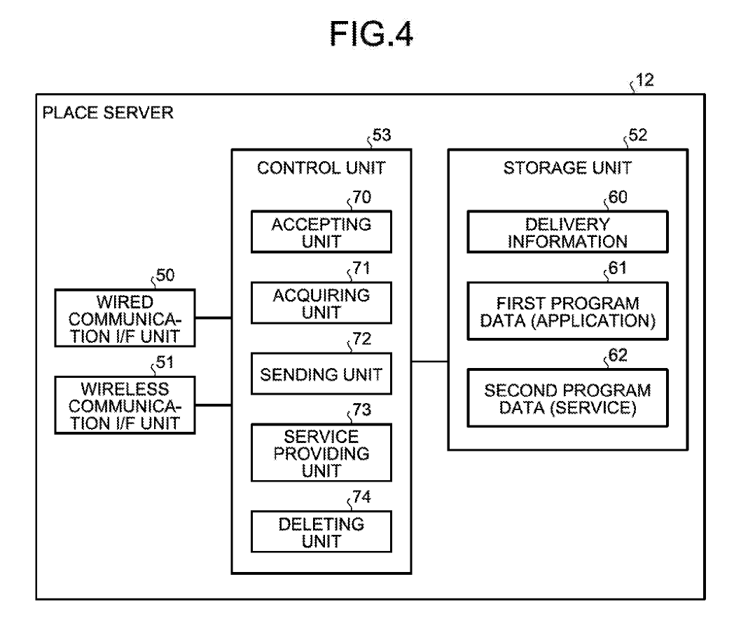

In the following, the configuration of the place server 12 according to the first embodiment will be described. FIG. 4 is a schematic diagram illustrating, in outline, the configuration of a place server according to the first embodiment. The place server 12 includes a wired communication I/F unit 50, a wireless communication I/F unit 51, a storage unit 52, and a control unit 53.

The wired communication I/F unit 50 is an interface that performs communication control of wired communication. The wired communication I/F unit 50 sends and receives various kinds of information to and from another device via the network N. For example, the wired communication I/F unit 50 sends and receives various kinds of information to and from the management server 11 via the network N. As the wired communication I/F unit 50, a network interface card, such as a LAN card or the like, can be used.

The wireless communication I/F unit 51 is an interface that performs communication control of wireless communication. The wireless communication I/F unit 51 sends and receives various kinds of information to and from another device by using wireless communication. For example, the wireless communication I/F unit 51 sends and receives various kinds of information to and from the terminal device 13 by using wireless communication. As the wireless communication I/F unit 51, a network interface card, such as a wireless LAN module, or the like, can be used. Furthermore, in the embodiment, it is assumed that the place server 12 performs wired communication with the management server 11 and performs wireless communication with the terminal device 13; however, the place server 12 may also perform wireless communication with the management server 11.

The storage unit 52 is a storage device, such as a hard disk, an SSD, an optical disk, or the like. Furthermore, the storage unit 52 may also be a semiconductor memory, such as a RAM, a flash memory, an NVSRAM, or the like, that can rewrite data.

The storage unit 52 stores therein an OS or various kinds of programs executed by the control unit 53. Furthermore, the storage unit 52 stores therein various kinds of data that are used in the programs executed by the control unit 53. For example, the storage unit 52 stores therein delivery information 60, first program data 61, and second program data 62.

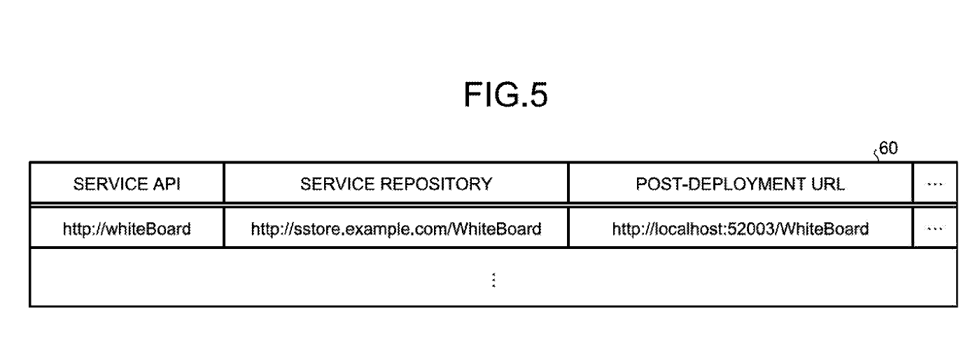

The delivery information 60 is data that stores therein information related to the service that is delivered from the management server 11. FIG. 5 is a schematic diagram illustrating an example of the data structure of delivery information. As illustrated in FIG. 5, the delivery information 60 includes items, such as the “service API”, the service repository”, the “post-deployment URL”, and the like. Each of the items in the delivery information 60 illustrated in FIG. 5 is an example and another item may also be included. Furthermore, the data structure of the delivery information 60 is an example and is not limited to this.

The item of the service API is an area that stores therein definition information that accepts call to a service. The item indicated by the service API stores therein, as the definition information, information on the API that accepts call to the service. The item of the service repository is an area that stores therein the repository location on the management server 11 side of the program of the service. The item of the post-deployment URL is an area that stores therein the URL that accepts call to the service when the program of the service is delivered. The item of the post-deployment URL stores therein “-” if the program of the service has not been delivered from the management server 11, i.e., has not been deployed, and stores therein the URL that accepts call to the service if the program of the service has been delivered from the management server 11, i.e., is deployed.

In the example illustrated in FIG. 5, it is indicated that the API that accepts call to the service is “http://WhiteBoard”. Furthermore, it is indicated that the repository location on the management server 11 side of the program of the service is “http://sstore.example.com/WhiteBoard” and the URL that accepts call of the delivered program of the service is “http://localhost:52003/WhiteBoard”.

A description will be given here by referring back to FIG. 4. The first program data 61 is data that stores therein the program of the application delivered from the management server 11. The second program data 62 is the data that stores therein the program of the service delivered from the management server 11.

The control unit 53 is a device that controls the place server 12. As the control unit 53, an electronic circuit, such as a CPU, an MPU, and the like, or an integrated circuit, such as an ASIC, an FPGA, and the like, can be used. The control unit 53 includes an internal memory that stores therein control data and programs in which various kinds of procedures are prescribed, whereby the control unit 53 performs various kinds of processes. The control unit 53 functions as various kinds of processing units by various kinds of programs being operated. For example, the control unit 53 includes an accepting unit 70, an acquiring unit 71, a sending unit 72, a service providing unit 73, and a deleting unit 74.

The accepting unit 70 performs various kinds of acceptance. For example, the accepting unit 70 accepts an access request from the terminal device 13. Here, in the embodiment, the accepting unit 70 accepts a request from the terminal device 13 in two stages. For example, the accepting unit 70 accepts a check-in request as an access request from the terminal device 13. Furthermore, if the definition information on the service is delivered from the management server 11, the accepting unit 70 further accepts a call of the service that is defined in the delivered definition information. For example, the accepting unit 70 accepts a call of the API of the service from the terminal device 13.

The acquiring unit 71 performs various kinds of acquisition. For example, if the acquiring unit 71 accepts an access request from the accepting unit 70, the acquiring unit 71 notifies the management server 11 of the status of the terminal device 13 that has accepted the access request or the status of the place server 12 and acquires the program of the application and the program of the service that are in accordance with the status. Here, in the first embodiment, the acquiring unit 71 acquires, in a different timing, the program of the application and the program of the service that is used by the subject application. For example, when the acquiring unit 71 accepts an access request, the acquiring unit 71 acquires the program of the application and the definition information that accepts call to the service that is used by the subject application. When the service defined in the acquired definition information is called, the acquiring unit 71 acquires the program of the service defined in the definition information.

For example, if the acquiring unit 71 accepts a check-in request as an access request, the acquiring unit 71 notifies the management server 11 of the status of the terminal device 13 included in the check-in request. Consequently, the management server 11 delivers the program of the application, the definition information on the API that accepts call to the service, and the repository location of the program of the service that are in accordance with the status notified by the place server 12.

The acquiring unit 71 acquires the program of the application, the definition information on the API that accepts call to the service, and the repository location of the program of the service that are delivered from the management server 11. The acquiring unit 71 stores the acquired program of the application in the first program data 61. Furthermore, the acquiring unit 71 stores, in the delivery information 60, the acquired definition information on the API that accepts call to the service and the repository location of the program of the service. Furthermore, the acquiring unit 71 registers the API in the OS on the basis of the acquired definition information on the API that accepts call to the service. Consequently, the API of the service can be called from the terminal device 13.

Furthermore, if the acquiring unit 71 receives a call of the API of the service from the accepting unit 70, the acquiring unit 71 refers to the delivery information 60 and determines whether the program of the service of the called API has already been deployed. If the program of the service has not been delivered, the acquiring unit 71 specifies the repository location on the management server 11 side of the program of the service and then requests the program of the service from the management server 11. Consequently, the management server 11 delivers the program of the service that is in accordance with the request.

The acquiring unit 71 acquires the program of the service delivered from the management server 11. The acquiring unit 71 stores the acquired program of the service in the second program data 62. Furthermore, the acquiring unit 71 registers the URL that accepts call of the delivered program of the service in the delivery information 60.

The sending unit 72 performs various kinds of transmission. For example, the sending unit 72 transmits the program of the application acquired by the acquiring unit 71 to the terminal device 13 that is the access request source. Consequently, in the terminal device 13, the application can be used.

The service providing unit 73 provides various kinds of services. For example, the service providing unit 73 executes the program of the service acquired by the acquiring unit 71 and starts up the service. Then, the service providing unit 73 performs the process of the service in accordance with the call of the API from the application in the terminal device 13.

The deleting unit 74 deletes various kinds of data. For example, the deleting unit 74 stops the service that satisfies a predetermined deletion condition and deletes the program of the subject service from the second program data 62. Furthermore, the deleting unit 74 deletes the API of the deleted service from the OS. Furthermore, the deleting unit 74 deletes the record related to the deleted service from the delivery information 60. The deletion condition may also be a case in which a predetermined time period has elapsed after the last access from the terminal device 13 or may also be a case in which the most recent access frequency becomes equal to or less than a predetermined threshold. Furthermore, the deletion condition may also be a case in which a check-out request is received from all of the terminal devices 13 each of which has sent an application that accepts call to a service.

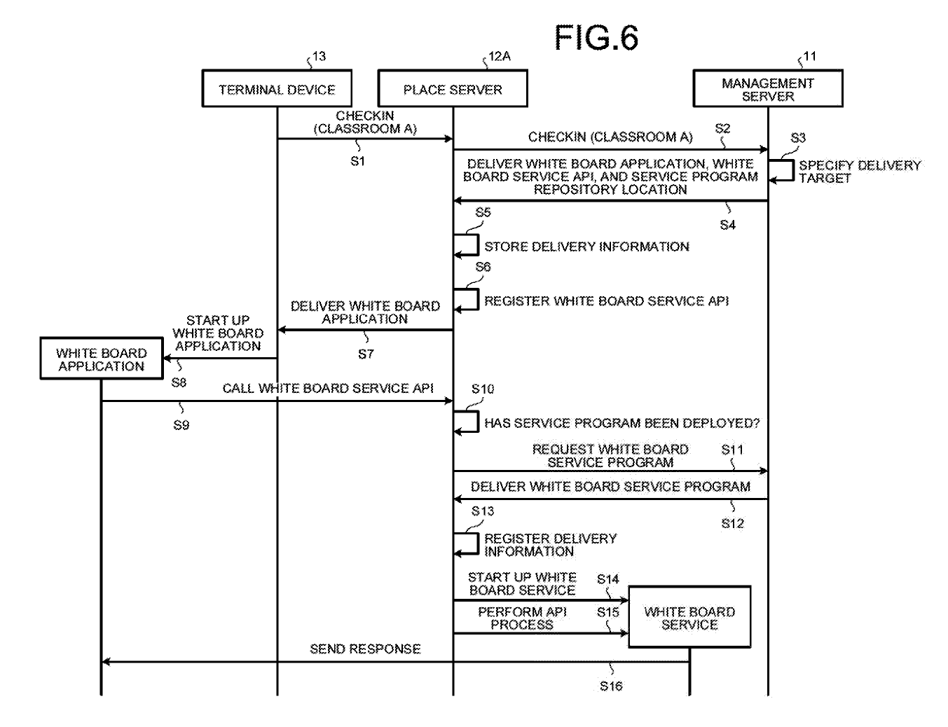

In the following, the flow of a process of deploying a service performed by the system 10 according to the first embodiment will be described. FIG. 6 is a schematic diagram illustrating, in outline, the flow of a process of deploying a service performed by the system according to the first embodiment. The example illustrated in FIG. 6 indicates the flow of the process of deploying a service to the place server 12A that is arranged in the classroom A.

For example, if a user moves to the classroom A, the terminal device 13 held by the user receives information indicating that the location is the classroom A from the status notification device that is arranged in the classroom A. If the terminal device 13 becomes available to perform wireless communication with the place server 12A, the terminal device 13 sends a check-in request including the information, as the status, indicating that the location is the classroom A (Step S1).

If the place server 12A accepts a check-in request, the place server 12A notifies the management server 11 of the information, as the status, indicating that the location included in the check-in request is the classroom A (Step S2).

If the status is notified by the place server 12A, the management server 11 refers to the delivery information 60 and specifies the application, the definition information on the API that accepts call to the service used by the application, and the repository location of the program of the service that are in accordance with the notified status (Step S3). For example, if the delivery information 60 is the state illustrated in FIG. 3, when the information indicating that the location is the classroom A is notified as the status, the application is specified as “white board application”. Furthermore, the API that accepts call to the service is specified as “http://WhiteBoard”. Furthermore, the repository location of the program of the service is specified as “http://sstore.example.com/WhiteBoard”. The management server 11 delivers, to the place server 12A, the program of the application, the definition information on the API that accepts call to the service, and the repository location of the program of the service that are specified (Step S4). For example, if the delivery information 60 is in the state illustrated in FIG. 3, the management server 11 delivers, to the place server 12A, the program of the white board application, the API that accepts call to the white board service, and the repository location of the program of the service.

The place server 12A stores, in the delivery information 60, the definition information on the API that accepts call to the service and the repository location of the program of the service delivered from the management server 11 (Step S5).

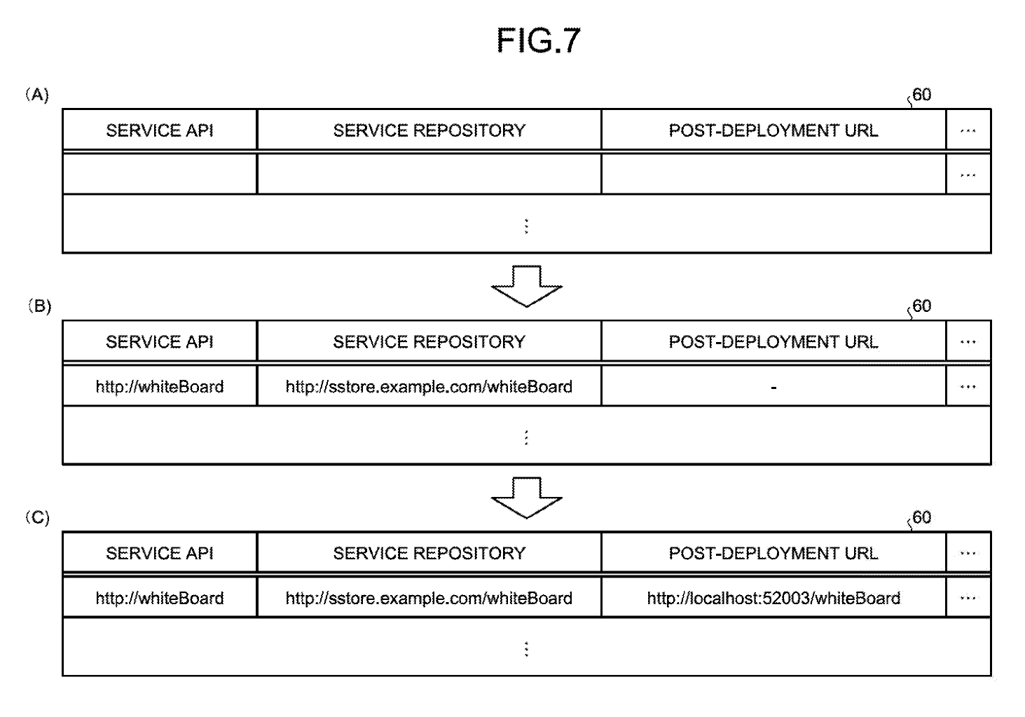

FIG. 7 is a schematic diagram illustrating an example of a change in data stored in the delivery information. The portion represented by (A) illustrated in FIG. 7 indicates the delivery information 60 in the initial state and data has not been stored. The portion represented by (B) illustrated in FIG. 7 indicates the result after the process at Step S5 has been performed. As indicated by (B) illustrated in FIG. 7, “http://WhiteBoard” is stored in the item of the service API. Furthermore, “http://sstore.example.com/WhiteBoard” is stored in the item of the service repository. Here, because the program of the service has not been delivered, the item of the post-deployment URL is “-” indicating undelivered.

The place server 12A registers the API that accepts call to the white board service in the OS (Step S6). Furthermore, the place server 12A sends the program of the white board application the terminal device 13 that is the request source of the check-in (Step S7).

The terminal device 13 executes the program of the white board application and starts up the white board application (Step S8). After the startup, the white board application calls the API that accepts call to the white board service of the place server 12A (Step S9).

When the place server 12A receives a call of the API of the white board service, the place server 12A refers to the delivery information 60 and determines whether the program of the service of the called API has been deployed (Step S10). If the program of the service has not been deployed, the place server 12A requests the program of the white board service from the management server 11 (Step S11).

The management server 11 delivers the program of the white board service in accordance with the request (Step S12).

The place server 12A stores the program of the white board service delivered from the management server 11 in the second program data 62 and registers the URL that accepts call of the program of the white board service in the delivery information 60 (Step S13). The portion represented by (C) illustrated in FIG. 7 indicates the result after the process at Step S13 has been performed. As indicated by (C) illustrated in FIG. 7, the item of the post-deployment URL stores therein the URL that accepts call of the program of the white board service.

The place server 12A executes the program of the white board service delivered from the management server 11 and starts up the white board service (Step S14). The white board service performs the process of the API called by the terminal device 13 (Step S15) and sends the processing result as a response to the terminal device 13 (Step S16).

Flow of the Process

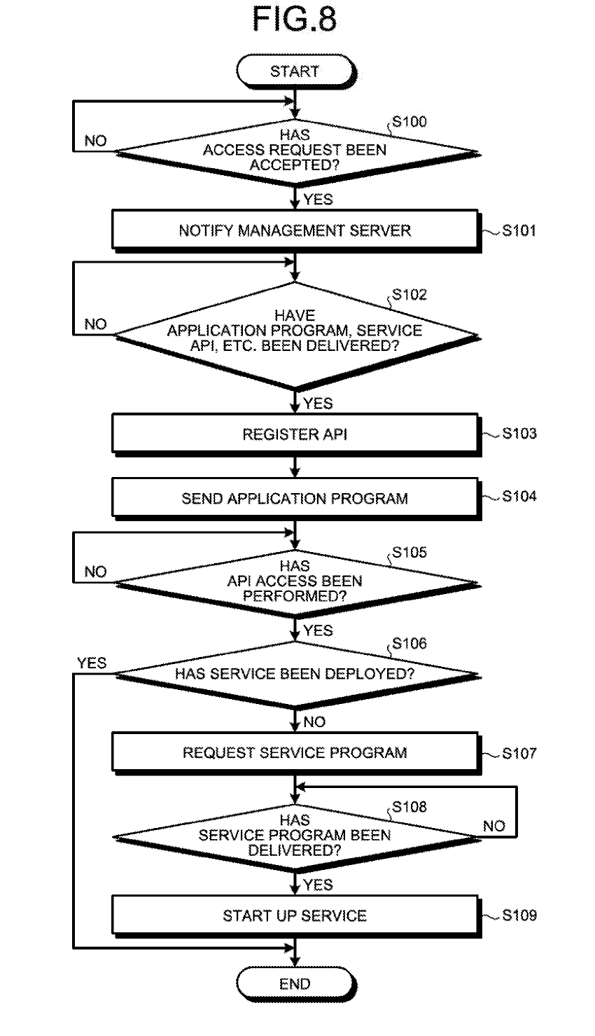

In the following, the flow of the process performed by each of the devices in the system 10 according to the first embodiment will be described. First, a description will be given of the flow of a control process in which the place server 12 according to the first embodiment controls deployment of the service. FIG. 8 is a flowchart illustrating an example of the flow of the control process performed by the place server. This control process is repeatedly performed. For example, the control process is repeatedly performed every time the process has been ended.

As illustrated in FIG. 8, the accepting unit 70 determines whether an access request has been accepted from the terminal device 13 (Step S100). If the access request has not been accepted (No at Step S100), the process again moves to Step S100.

In contrast, if the access request has been accepted (Yes at Step S100), the acquiring unit 71 notifies the management server 11 of the status of the terminal device 13 that has accepted the access request (Step S101). The acquiring unit 71 determines whether the program of the application, the definition information of the API that accepts call to the service, and the program of the service have been delivered from the management server 11 (Step S102). If the delivery has not been performed (No at Step S102), the process again moves to Step S102.

If the delivery has been performed (Yes at Step S102), the acquiring unit 71 stores the definition information of the API that accepts call to the delivered service and the repository location of the program of the service in the delivery information 60 and registers the API of the service in the OS on the basis of the definition information of the API that accepts call to the service (Step S103). The sending unit 72 sends the program of the delivered application to the terminal device 13 that is the access request source (Step S104).

The accepting unit 70 determines whether the API of the registered service has been called (Step S105). If the API has not been called (No at Step S105), the process again moves to Step S105.

In contrast, if the API is called (Yes at Step S105), the acquiring unit 71 determines whether the program of the service of the called API has been deployed (Step S106). If the deployment has already been performed (Yes at Step S106), the acquiring unit 71 ends the process.

In contrast, if the deployment has not been performed (No at Step S106), the acquiring unit 71 specifies the repository location on the management server 11 side of the program of the service and requests the program of the service from the management server 11 (Step S107). The acquiring unit 71 determines whether the program of the service has been delivered (Step S108). If the program of the service has not been delivered (No at Step S108), the process again moves to Step S108.

In contrast, if the program of the service is delivered (Yes at Step S108), the sending unit 72 executes the program of the service acquired by the acquiring unit 71 and starts up the service (Step S109) and ends the process.

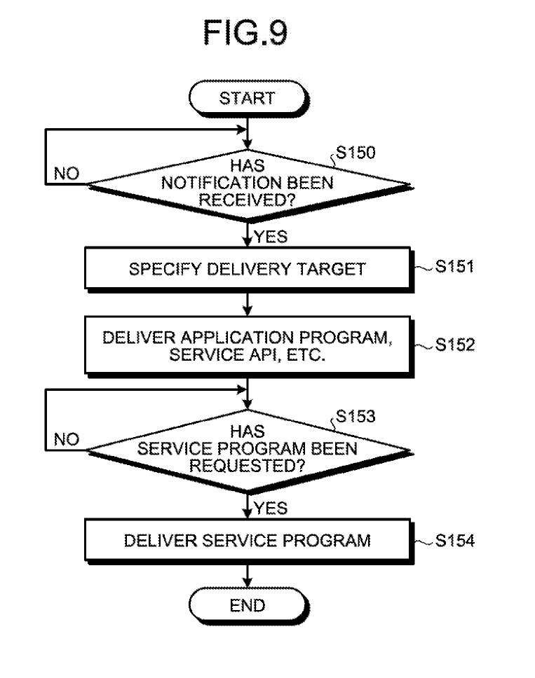

In the following, the flow of the control process in which the management server 11 according to the first embodiment controls deployment of the service will be described. FIG. 9 is a flowchart illustrating an example of the flow of the control process performed by the management server. This control process is repeatedly performed. For example, the control process is repeatedly performed every time the process ends.

As illustrated in FIG. 9, the delivery unit 40 determines whether the status is notified from the place server 12 (Step S150). If the status is not notified (No at Step S150), the process again moves to Step S150.

In contrast, if the status is notified (Yes at Step S150), the delivery unit 40 refers to the delivery definition information 30. The delivery unit 40 specifies the application, the definition information on the API that accepts call to the service that is used by the application, and the repository location of the program of the service that are in accordance with the notified status (Step S151). The delivery unit 40 delivers, to the place server 12 that is the notification resource, the program of the specified application, the definition information on the API that accepts call to the service, and the repository location of the program of the service (Step S152).

The delivery unit 40 determines whether the program of the service has been requested from the place server 12 (Step S153). If the request has not been performed (No at Step S153), the process again moves to Step S153.

In contrast, if the request has been performed (Yes at Step S153), the delivery unit 40 delivers the program of the service that is in accordance with the request (Step S154) and ends the process.

Effects

The system 10 according to the embodiment includes the management server 11 and the place server 12. The management server 11 stores therein the program of the application that is used in the terminal device 13 and the program of the service that is used by the subject application. The management server 11 delivers the program of the application and the program of the service that are in accordance with the status notified by the place server 12. The place server 12 accepts the access request from the terminal device 13. The place server 12 notifies the management server 11 of the status of the terminal device 13 from which the access request has accepted or the status of the place server 12 and acquires the program of the application and the program of the service. The place server 12 sends the acquired program of the application to the terminal device 13. The place server 12 provides the service due to the acquired program of the service. Consequently, the system 10 can appropriately deploy the service to the place server 12 in accordance with the status. For example, if the white board application or the white board service that shares a virtual white board is used in the classroom A, as illustrated in FIG. 6, the white board application and the program of the white board service can be delivered to the place server 12A that is arranged in the classroom A. Furthermore, application and the program of the service that are used in another location are not delivered to the place server 12A. Namely, an unused application and the program of the service are not delivered to the place server 12. Consequently, even if a device has a small resource, such as the storage capacity, the place server 12 can provide the service. Furthermore, the management server 11 stores therein the program of the application and the program of the service, whereby the management server 11 can manage, in an integrated manner, the program of the application and the program of the service that are used in each of the locations. Furthermore, an application and a program of a service are delivered to the place server 12 in the timing in which an access request is received from the terminal device 13. Consequently, the latest application and the program of the service at the time of reception of the access request can be delivered to the place server 12 and the terminal device 13. Furthermore, even if the place server 12 is moved to another location, the application and the program of the service that are in accordance with the location are delivered to the place server 12. Namely, in the system 10, by moving the place server 12, a plurality of locations can be used in a shared manner.

Furthermore, when the place server 12 according to the embodiment accepts the access request from the terminal device 13, the place server 12 acquires the program of the application and the definition information that accepts call to the service that is used by the subject application. If the service that is defined in the acquired definition information is called, the place server 12 acquires the program of the service defined in the subject definition information. Consequently, it is possible to deploy, in the place server 12, only the service that is called from the terminal device 13 and that is actually used. For example, if the white board application or the white board service that shares a virtual white board is used in the classroom A, as illustrated in FIG. 6, it is possible to deliver the program of the white board service to the place server 12A in the timing in which the white board application is actually used. Furthermore, in the system 10, because the definition information that accepts call to the service is delivered to the place server 12 first, the transfer time can be reduced when compared with a case in which the program of the service is transferred. Consequently, the place server 12 can send the application to the terminal device 13 in the early timing. Consequently, the user of the terminal device 13 can use the application in the early timing.

### [b] Second Embodiment

In the following, a second embodiment will be described. In the second embodiment, a description will be given of a case in which a program of a service is received in the background without the place server 12 waiting for a call of the API of the service.

The configuration of the system 10, the management server 11, the place servers 12, and the terminal devices 13 according to the second embodiment is substantially the same as that of the first embodiment illustrated in FIGS. 1 to 5; therefore, only the parts that differ will mainly be described.

In also the second embodiment, the acquiring unit 71 acquires the program of the application and the program of the service that is used by the application in different timing. For example, when the accepting unit 70 accepts an access request, the accepting unit 70 acquires the program of the application and the definition information that accepts call to the service that is used by the subject application. Subsequently, the accepting unit 70 acquires the program of the service defined in the acquired definition information. Namely, the accepting unit 70 acquires the program of the service in the background without waiting for a call of the API of the service.

For example, if the acquiring unit 71 accepts a check-in request as an access request, the acquiring unit 71 notifies the management server 11 of the status of the terminal device 13 included in the check-in request. Consequently, the management server 11 delivers the program of the application the definition information on the API that accepts call to the service, and the repository location of the program of the service that are in accordance with the status notified by the place server 12.

The acquiring unit 71 acquires the program of the application, the definition information on the API that accepts call to the service, and the repository location of the program of the service that are delivered from the management server 11. If the acquiring unit 71 acquires the definition information, the acquiring unit 71 specifies the repository location on the management server 11 side of the program of the service stored in the definition information and requests the program of the service from the management server 11. Consequently, the management server 11 delivers the program of the service in accordance with the request.

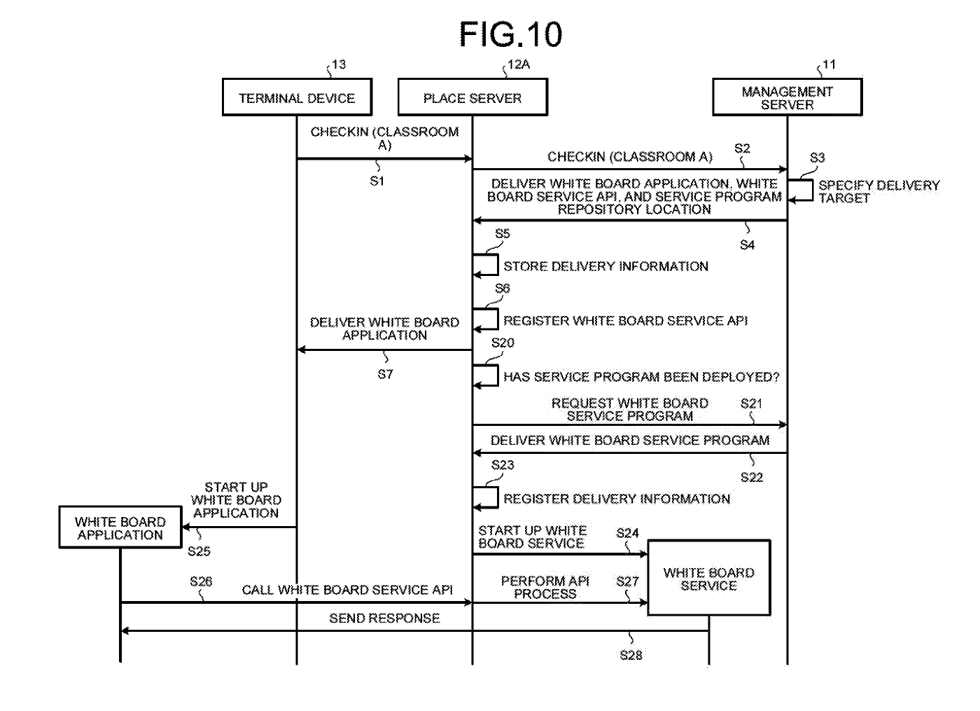

Then, the flow of the process in which the system 10 according to the second embodiment deploys a service will be described. FIG. 10 is a schematic diagram illustrating, in outline, an example of the flow of a process of deploying a service performed by a system according to a second embodiment. A part of the flow of the process illustrated in FIG. 10 is the same as a part of that illustrated in FIG. 6; therefore, steps at each of which the same process is performed are assigned the same reference numerals and only the parts that differ will mainly be described.

The place server 12A registers the API that accepts call to a white board service in the OS (Step S6). Furthermore, the place server 12A sends the program of the white board application to the terminal device 13 that is the request source of the check-in (Step S7).

The place server 12A refers to the delivery information 60 and determines whether the program of the service of the registered API has been deployed (Step S20). If the program of the service has not been deployed, the place server 12A requests the program of the white board service from the management server 11 (Step S21).

The management server 11 delivers the program of the white board service in accordance with the request (Step S22).

The place server 12A stores the program of the white board service delivered from the management server 11 in the second program data 62 (Step S23). The place server 12A executes the program of the white board service and starts up the white board service (Step S24).

The terminal device 13 executes the program of the white board application and starts up the white board application (Step S25). If the white board application is started up, the white board application calls the API that calls the white board service of the place server 12A (Step S26).

The white board service executes the process of the API that is called from the terminal device 13 (Step S27) and sends the processing result to the terminal device 13 as a response (Step S28).

Flow of the Process

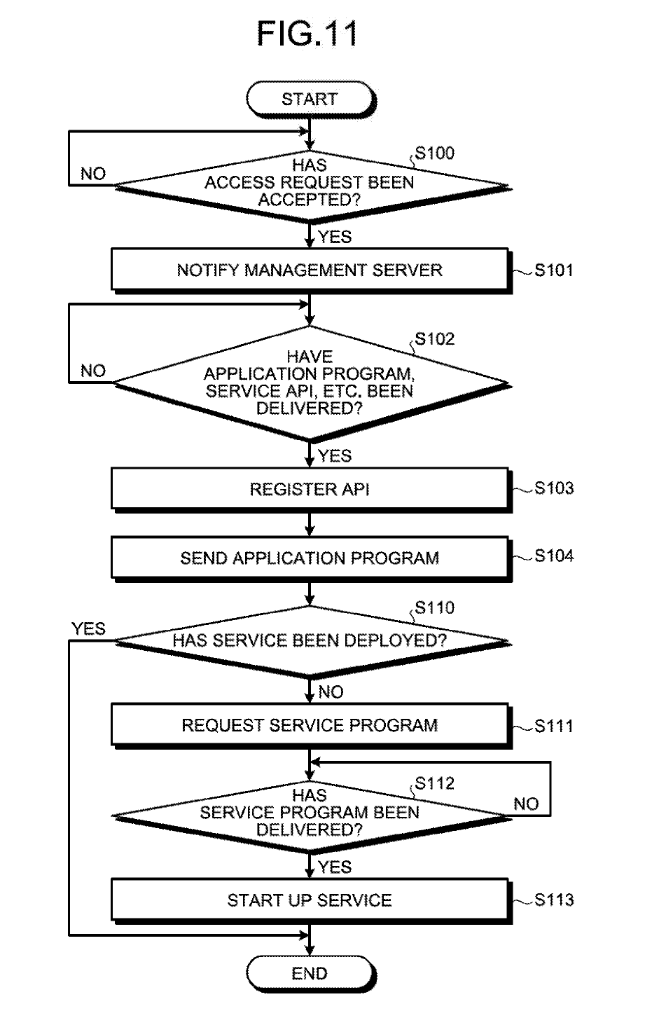

In the following, a description will be given of the flow of a control process in which the place server 12 according to the second embodiment controls deployment of the service. FIG. 11 is a flowchart illustrating an example of the flow of the control process performed by a place server. A part of the flow of the process illustrated in FIG. 11 is the same as a part of that illustrated in FIG. 8; therefore, steps at each of which the same process is performed are assigned the same reference numerals and only the parts that differ will mainly be described

The sending unit 72 sends the program of the delivered application to the terminal device 13 that is the access request source (Step S104).

The acquiring unit 71 determines whether the program of the service of the API registered at Step S103 has already been deployed (Step S110). If the deployment has been performed (Yes at Step S110), the acquiring unit 71 ends the process.

In contrast, if the deployment has not been performed (No at Step S110), the acquiring unit 71 specifies the repository location on the management server 11 side of the program of the service and requests the program of the service from the management server 11 (Step S111). The acquiring unit 71 determines whether the program of the service has been delivered (Step S112). If the program of the service has not been delivered (No at Step S112), the acquiring unit 71 again moves to Step S112.

In contrast, if the program of the service has been delivered (Yes at Step S112), the sending unit 72 executes the program of the service acquired by the acquiring unit 71, starts up the service (Step S113), and ends the process.

Effects

When the place server 12 according to the embodiment accepts an access request from the terminal device 13, the place server 12 acquires the program of the application and the definition information that accepts call to the service that is used by the subject application. The place server 12 subsequently acquires the program of the service defined in the acquired definition information. Consequently, in the system 10, because the definition information that accepts call to the service is delivered to the place server 12 first, the transfer time can be reduced when compared with a case in which the program of the service is transferred. Furthermore, the place server 12 can send the application to the terminal device 13 in the early timing. Consequently, a user of the terminal device 13 can use the application in the early timing. Furthermore, because the place server 12 subsequently acquires the program of the service defined in the definition information after acquiring the definition information, when compared with the case in which the program of the service is transferred after the service is called, the program of the service can promptly be acquired and the service can promptly be started up. Consequently, the place server 12 can reduce the waiting time of a first call of the service after the application has been started up in the terminal device 13.

### [c] Third Embodiment

Then, a third embodiment will be described. In the third embodiment, a case of deploying a service that satisfies a condition will be described.

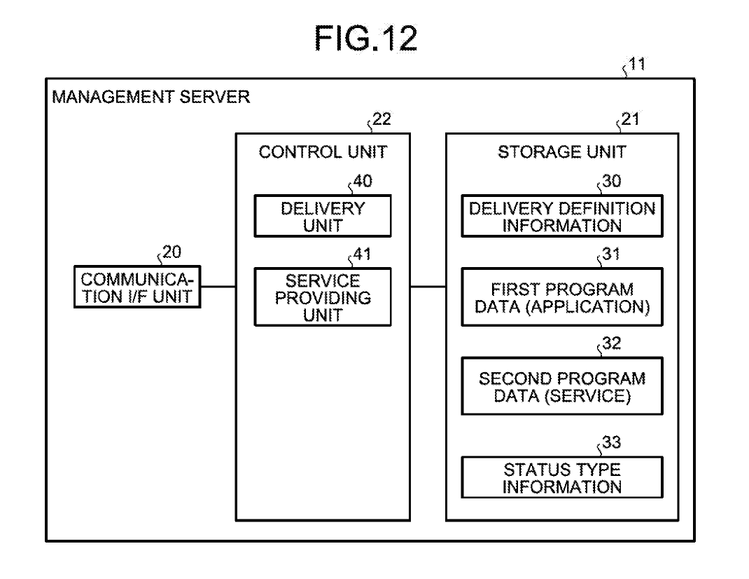

The configuration of the system 10 according to the third embodiment is substantially the same as that of the first embodiment illustrated in FIG. 1; therefore, a description thereof will be omitted. FIG. 12 is a schematic diagram illustrating, in outline, the configuration of a management server according to a third embodiment. A part of the configuration of the management server 11 according to the third embodiment is the same as a part of that of the management server 11 according to the first embodiment illustrated in FIG. 2; therefore, components that are the same as those in the first embodiment are assigned the same reference numerals; therefore, only the parts that differ will mainly be described.

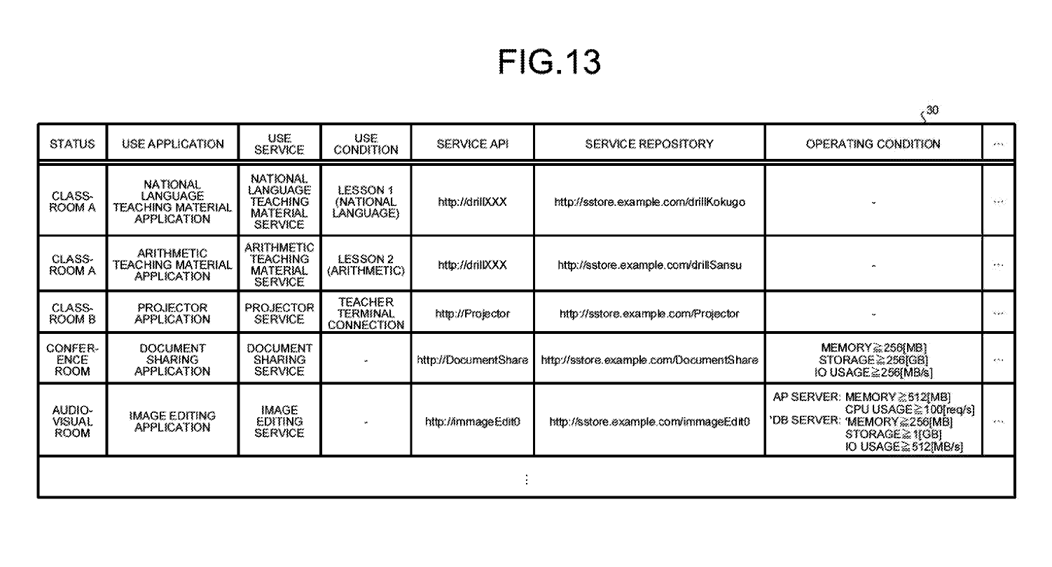

The delivery definition information 30 further stores therein the information related to the condition for deploying an application or a service. FIG. 13 is a schematic diagram illustrating an example of the data structure of delivery definition information according to the third embodiment. A part of the data structure of the delivery definition information 30 according to the third embodiment is the same as a part of that of the delivery definition information 30 according to the first embodiment illustrated in FIG. 3; therefore, only the parts that differ will mainly be described.

As illustrated in FIG. 13, the delivery definition information 30 further includes items of the “use condition” and the “operating condition”. Furthermore, each of the items in the delivery definition information 30 illustrated in FIG. 13 is an example and another item may also be included. Furthermore, the data structure of the delivery definition information 30 is also an example and is not limited to this.

The item of the use condition is an area that stores therein the condition in which the application and the service can be used. If the use condition is not present, the item of the use condition is represented by “-”, whereas, if the use condition is present, the status that can be used is stored. The item of the operating condition is an area that stores therein the condition of the resource that is used when the service is operated by the place server 12. If the operating condition is not present, the item of the operating condition is represented by “-”, whereas, if the operating condition is present, the status that can be operated is stored. Furthermore, if services can be distributed to different servers for each function, the operating condition can be determined for each function of the service. For example, if the service can be arranged in a distributed manner, such as an application (AP) server and a database (DB) server, the operating condition can be determined in each of the AP server and the DB server.

In the example illustrated in FIG. 13, it is indicated that the status of the “classroom A”, a combination of a “national language teaching material application” and a “national language teaching material service” and a combination of an “arithmetic teaching material application” and an “arithmetic teaching material service” can be used. Furthermore, it is indicated that the “national language teaching material application” and the “national language teaching material service” can be used in the time zone of a lesson 1 that is the national language lesson. It is indicated that the “arithmetic teaching material application” and the “arithmetic teaching material service” can be used in the time zone of a lesson 2 that is the arithmetic lesson. Furthermore, regarding the “national language teaching material service”, it is indicated that the API that accepts call to the service is “http://drillXXX”; the repository location of the program of the service is “http://sstore.example.com/drillKokugo”; and operating condition is not present. Regarding the “arithmetic teaching material service”, it is indicated that the API that accepts call to the service is “http://drillXXX”; the repository location of the program of the service is “http://sstore.example.com/drillSansu”; and the operating condition is not present.

Regarding the status of the “classroom B”, it is indicated that the “projector application” and the “projector service” can be used. Furthermore, it is indicated that the “projector application” and the “projector service” can be used when the terminal device 13 of the teacher is connected. Furthermore, regarding the “projector service”, it is indicated that the API that accepts call to the service is “http://Projector”, the repository location of the program of the service is “http://sstore.example.com/Projector”, and the operating condition is not present.

Regarding the status of the “conference room”, it is indicated that the “document sharing application” and the “document sharing service” can be used. Furthermore, regarding the “document sharing application” and the “document sharing service”, it is indicated that the use condition is not present. Furthermore, regarding the “document sharing service”, it is indicated that the API that accepts call to the service is “http://DocumentShare” and the repository location of the program of the service is “http://sstore.example.com/DocumentShare”. Furthermore, if the “document sharing service” is operated in the place server 12, it is indicated that “memory≧256 [MB], storage≧256 [GB], and IO usage≧256 [MB/s]” are the operating condition.

The status of an “audio-visual room” indicates that an “image editing application” and an “image editing service” can be used. Furthermore, regarding the “image editing application” and the “image editing service”, it is indicated that the use condition is not present.

Furthermore, regarding the “image editing service”, it is indicated that the API that accepts call to the service is “http://immageEdit0” and the repository location of the program of the service is “http://sstore.example.com/immageEdit0”. Furthermore, it is indicated that the “image editing service” can be separately arranged in the AP server and the DB server. It is indicated that the operating condition of the AP server is “memory≧512 [MB] and CPU usage≧100 [req/s]” and the operating condition of the DB server is “memory ≧256 [MB], storagel [GB], and IO usage≧512 [MB/s]”. The symbol represented by [req/s] indicates the number of average process requests received per second.

A description will be given here by referring back to FIG. 12. The storage unit 21 in the management server 11 further stores therein status type information 33.

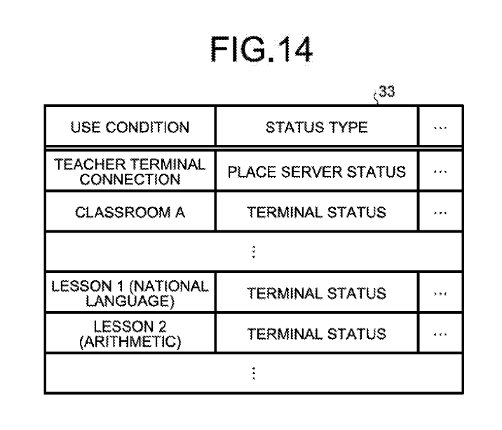

The status type information 33 is data that stores therein information related to the type of the status that is set as the use condition. FIG. 14 is a schematic diagram illustrating an example of the data structure of the status type information. As illustrated in FIG. 14, the status type information 33 includes the items of the “use condition” and the “status type”. Each of the items of the status type information 33 illustrated in FIG. 14 is an example and another item may also be included. Furthermore, the data structure of the status type information 33 is only an example and is not limited to this.

The item of the use condition is an area that stores therein the condition that is determined as the use condition. The item of the status type is an area that stores therein the type of the status that is used to determine the use condition. In the embodiment, as the type of the status, which of the status of the terminal device 13 and the status of the place server 12 is used to determine the use condition.

The example illustrated in FIG. 14 indicates that the status of the place server 12 is used to determine whether the terminal device 13 of the teacher is connected. Furthermore, the status of the terminal device 13 is used to determine whether the status is the classroom A. Furthermore, the status of the terminal device 13 is used to determine whether the lesson 1 is performed. The status of the terminal device 13 is used to determine whether the lesson 2 is performed.

A description will be given here by referring back to FIG. 12. The delivery unit 40 delivers, together with the definition information that accepts call to the service, the use condition of the subject service, the operating condition, and the status type information 33. Furthermore, the delivery unit 40 may also read only the data, in the status type information 33, of the record associated with the use condition to be delivered.

Furthermore, the control unit 22 further includes a service providing unit 41. The service providing unit 41 provides various kinds of services. For example, if the API of the service is called, the service providing unit 41 executes the program of the service of the called API and starts up the service. Then, the service providing unit 41 performs the process in accordance with the call.

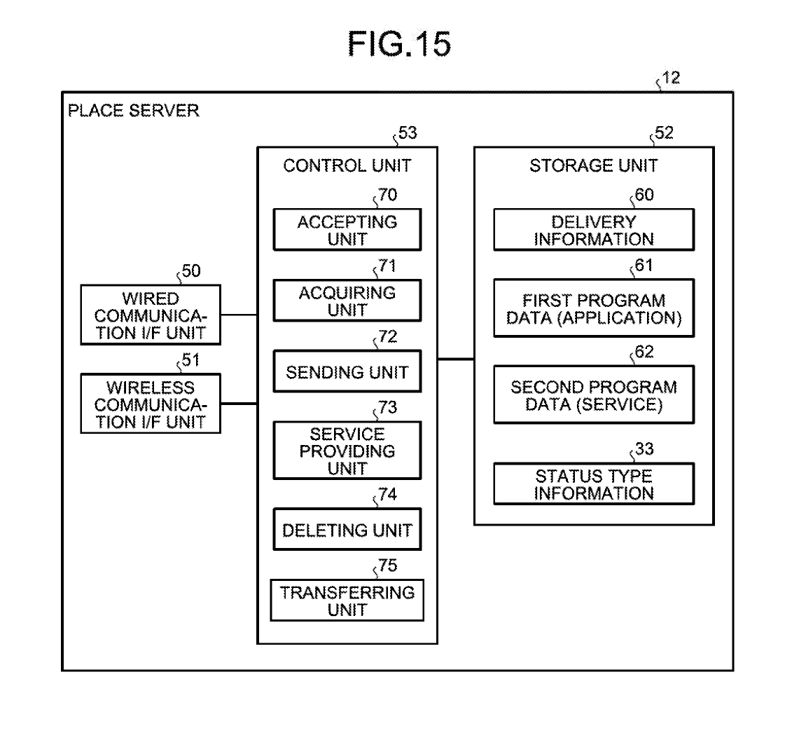

In the following, the configuration of the place server 12 according to the third embodiment will be described. FIG. 15 is a schematic diagram illustrating, in outline, the configuration of a place server according to the third embodiment. A part of the configuration of the place server 12 according to the third embodiment is the same as a part of that of the place server 12 according to the first embodiment illustrated in FIG. 4; therefore, components that are the same as those in the first embodiment are assigned the same reference numerals; therefore, only the parts that differ will mainly be described.

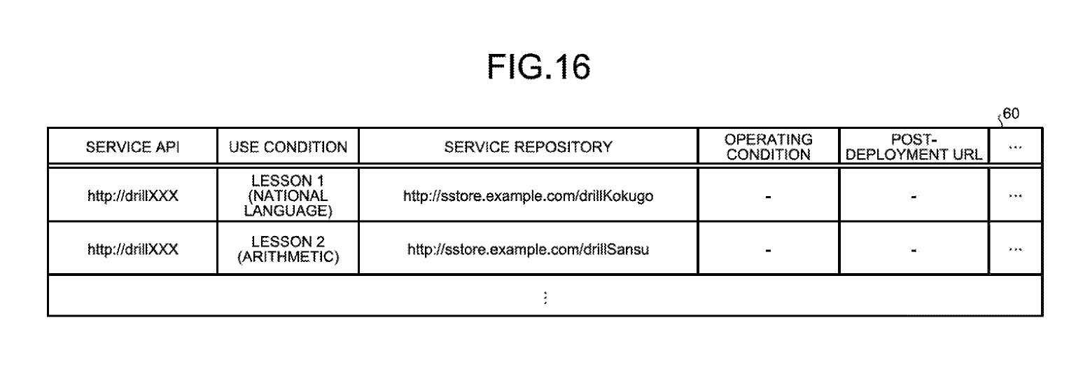

The delivery information 60 further stores therein information related to the condition for deploying the applications or the services delivered from the management server 11. FIG. 16 is a schematic diagram illustrating an example of the data structure of delivery information according to the third embodiment. A part of the data structure of the delivery information 60 according to the third embodiment is the same as a part of that of the delivery information 60 according to the first embodiment illustrated in FIG. 5; therefore, only the parts that differ will mainly be described.

As illustrated in FIG. 16, the delivery information 60 further includes therein the items of the “use condition” and the “operating condition”. Furthermore, each of the items of the delivery information 60 illustrated in FIG. 16 is an example and another item may also be included. Furthermore, the data structure of the delivery information 60 is an example and is not limited to this.

The item of the use condition is an area that stores therein the use condition delivered from the management server 11. If the use condition is not present, the symbol represented by “-” is stored in the item of the use condition, whereas, if the use condition is present, the status that can be used is stored. The item of the operating condition is an area that stores therein the operating condition delivered from the management server 11. In also the item of the operating condition, if the operating condition is not present, the symbol represented by “-” is set, whereas, if the operating condition is present, the status of the resource that can be operated is stored.

In the example illustrated in FIG. 16, two APIs of “http://drillXXX” that accepts call to the services are registered. The first API indicates that the use condition is the lesson 1, the repository location on the management server 11 side of the program of the service is “http://sstore.example.com/drillKokugo”, the operating condition is not present, and the program of the service has not been deployed. The second API indicates that the use condition is a lesson 2, the repository location on the management server 11 side of the program of the service is “http://sstore.example.com/drillSansu”, the operating condition is not present, and the program of the service has not been deployed.

A description will be given here by referring back to FIG. 15. The storage unit 52 in the place server 12 further stores therein the status type information 33. The status type information 33 is data that stores therein the status type information 33 delivered from the management server 11.

The acquiring unit 71 acquires the use condition of the service delivered from the management server 11, the operating condition, and the status type information 33. The acquiring unit 71 stores the acquired use condition of the service and the operating condition in the delivery information 60. Furthermore, the acquiring unit 71 stores the acquired status type information 33 in the storage unit 52.

Furthermore, if the acquiring unit 71 receives a call of the API of the service from the accepting unit 70, the acquiring unit 71 determines whether the service of the called API satisfies the use condition of the subject service. For example, the acquiring unit 71 specifies, on the basis of the status type information 33, which of the status of the terminal device 13 and the status of the place server 12 is used to determine the use condition of the service. The acquiring unit 71 determines, by using the specified status, whether the use condition of the service is satisfied and specifies the service targeted for deployment that satisfies the use condition of the service.

Regarding the specified service targeted for deployment, the acquiring unit 71 determines whether the place server 12 satisfies the operating condition of the subject service. For example, the acquiring unit 71 specifies an amount of resource that can be used by the place server 12. For example, the acquiring unit 71 specifies an amount of resource that can be used by obtaining the current usage of the resource, such as the CPU usage, the usage of a memory, storage, an IO, or the like, and obtaining a difference with the maximum value that can be used by the resource. For example, if the maximum value of the CPU usage of the CPU is 1000 [req/s] and the current usage of the CPU is 100 [req/s], the amount of resource that can be used by the CPU is specified to 900 [req/s]. If the amount of resource that can be used by the place server 12 satisfies the operating condition of the service, the acquiring unit 71 determines that the place server 12 satisfies the operating condition. If the place server 12 satisfies the operating condition, the acquiring unit 71 requests the program of the service targeted for the deployment from the management server 11 and acquires the program of the service targeted for the deployment. Furthermore, regarding the service targeted for the deployment, if the operating condition is set for each function of the service that can be distributed in a server, the acquiring unit 71 determines whether the operating condition is satisfied for each function of the service that can be distributed. The acquiring unit 71 requests, from the management server 11, the program of the service that constitutes the function of the service that satisfies the operating condition and then acquires the program that constitutes the function of the service that satisfies the operating condition. For example, regarding the service targeted for deployment, if the operating condition is separately set in the AP server and the DB server, the acquiring unit 71 determines whether the amount of resource that can be used by the place server 12 satisfies the operating condition of the AP server and the DB server. If, for example, the amount of resource that can be used by the place server 12 satisfies the operating condition of the AP server and the DB server, the acquiring unit 71 acquires the program of the service that constitutes the AP server from the management server 11.

The service providing unit 73 executes the program of the service acquired by the acquiring unit 71 and starts up the service. Consequently, if the place server 12 satisfies the operating condition, the service targeted for the deployment is deployed to the place server 12. Furthermore, if the services that are targeted for the deployment can be arranged in different servers in a distributed manner for each function, a portion of the function in which the place server 12 satisfies the operating condition is deployed to the place server 12 from among each of the functions of the services targeted for the deployment. The service providing unit 73 executes the process of the service in accordance with a call of the API from the application in the terminal device 13.

The control unit 53 further includes a transferring unit 75. The transferring unit 75 performs various kinds of transfer. For example, if the place server 12 does not satisfy the operating condition of the service targeted for deployment, the transferring unit 75 transfers the call of the API of the subject service received from the terminal device 13 to the management server 11. Namely, regarding the service targeted for the deployment, if the place server 12 does not satisfy the operating condition, the call of the API of the subject service is transferred to the management server 11. Furthermore, the transferring unit 75 transfers, to the management server 11, a call of the API of the portion of the function in which the place server 12 does not satisfy the operating condition from among each of the functions of the services targeted for the deployment. The call of the API transferred by the management server 11 is deployed to the management server 11 and is processed by the service.

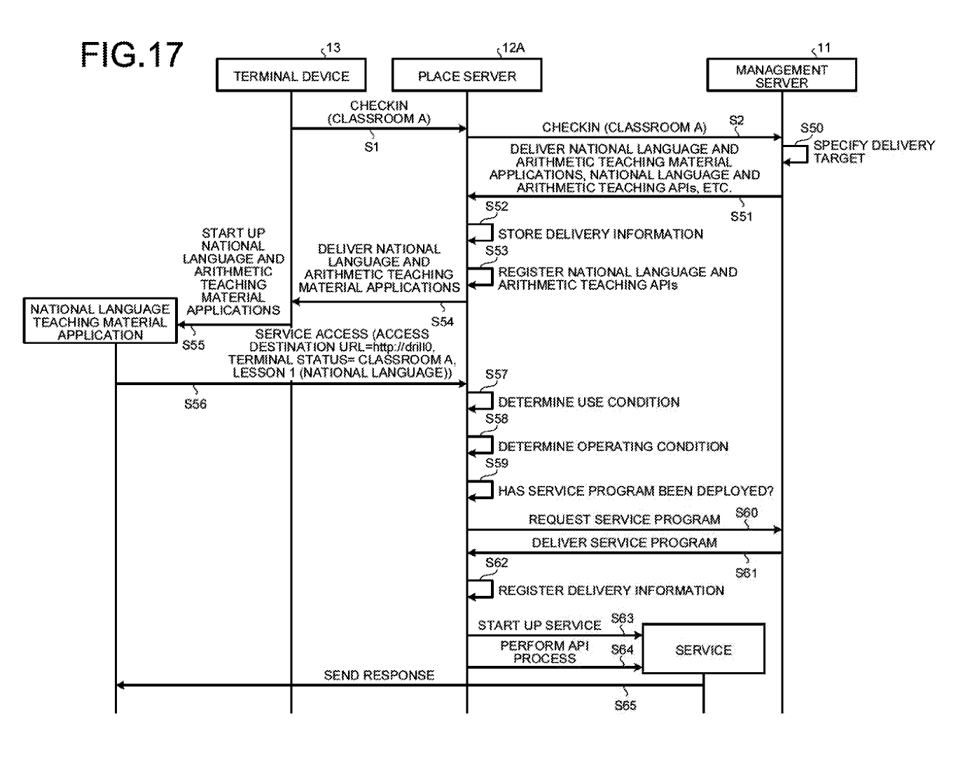

In the following, a description will be given of the flow of the process in which the system 10 according to the third embodiment deploys the service. FIG. 17 is a schematic diagram illustrating, in outline, an example of the flow of a process of deploying a service performed by a system according to the third embodiment. The example illustrated in FIG. 17 indicates the flow of the process of deploying the service to the place server 12A that is arranged in the classroom A. A part of the flow of the process illustrated in FIG. 17 is the same as a part of that illustrated in FIG. 6; therefore, steps at each of which the same process is performed are assigned the same reference numerals and only the parts that differ will mainly be described

If the status of the classroom A is notified from the place server 12A, the management server 11 refers to the delivery information 60. Then, the management server 11 specifies the application the definition information on the API that accepts call to the service that is used by the application, the repository location of the program of the service, and the use condition and the operating condition of the service that are in accordance with the notified status (Step S50). The management server 11 delivers, to the place server 12A, the specified program of the application, the definition information on the API that accepts call to the service, and the repository location of the program of the service (Step S51). For example, if the delivery information 60 is in the state illustrated in FIG. 13, the management server 11 delivers, to the place server 12A, the program of the national language teaching material application, the API that accepts call to the national language teaching material service, the repository location of the program of the service, and the use condition and the operating condition of the service. Furthermore, the management server 11 delivers, to the place server 12A, the program of the arithmetic teaching material application, the API that accepts call to the arithmetic teaching material service, the repository location of the program of the service, and the use condition and the operating condition of the service.

Regarding the national language teaching material service and the arithmetic teaching material service, the place server 12A stores, in the delivery information 60, the definition information on the API to be called, the repository location of the program of the service, and the use condition and the operating condition of the service (Step S52). Consequently, if the delivery information 60 is in the state illustrated in FIG. 13, the data illustrated in FIG. 16 is stored in the delivery information 60.

The place server 12A registers, in the OS, the API that accepts call to the national language teaching material service and the arithmetic teaching material service (Step S53). Here, regarding the national language teaching material service and the arithmetic teaching material service, because the definitions of the APIs are the same, one of the APIs is registered. Furthermore, the place server 12A sends the program of the national language teaching material application and the arithmetic teaching material application to the terminal device 13 that is the request source of check-in (Step S54).

In the terminal device 13, in accordance with the lesson to be conducted, the national language teaching material application or the arithmetic teaching material application is executed and the national language teaching material application or the arithmetic teaching material application is started up (Step S55). In the embodiment, it is assumed that the national language teaching material application is started up. After the startup, the national language teaching material application calls the API that accepts call to the national language teaching material service (Step S56). Because the API to be called for the national language teaching material application and the API to be called for the arithmetic teaching material application are the same, the terminal status, such as a location, a class, or the like, is attached to the call of the API. In the example illustrated in FIG. 17, the national language teaching material application attaches the classroom A and the lesson 1 as the terminal status.

If the place server 12A receives a call of the API, the place server 12A refers to the delivery information 60, determines whether the use condition of the service of the called API is satisfied, and specifies the service that is targeted for the deployment and that satisfies the use condition (Step S57). For example, regarding the national language teaching material service, the use condition is set to the “class 1”. Thus, the national language teaching material service is specified as the service that is targeted for the deployment. Regarding the service targeted for the deployment, the place server 12A determines whether the place server 12 satisfies the operating condition of the subject service (Step S58). Because the operating condition is not present in the national language teaching material service, it is determined that the place server 12 satisfies the operating condition.

The place server 12A refers to the delivery information 60 and determines whether the program of the national language teaching material service has been deployed (Step S59). If the program of the national language teaching material service has not been deployed, the place server 12A requests the program of the national language teaching material service from the management server 11 (Step S60).

The management server 11 delivers the program of the national language teaching material service in accordance with the request (Step S61).

The place server 12A stores the program of the national language teaching material service delivered from the management server 11 in the second program data 62 and registers the URL that accepts call of the program of the national language teaching material service in the delivery information 60 (Step S62).

The place server 12A executes the program of the national language teaching material service delivered from the management server 11 and starts up the national language teaching material service (Step S63). The national language teaching material service performs the process of the API that is called by the terminal device 13 (Step S64) and sends the processing result to the terminal device 13 as a response (Step S65).

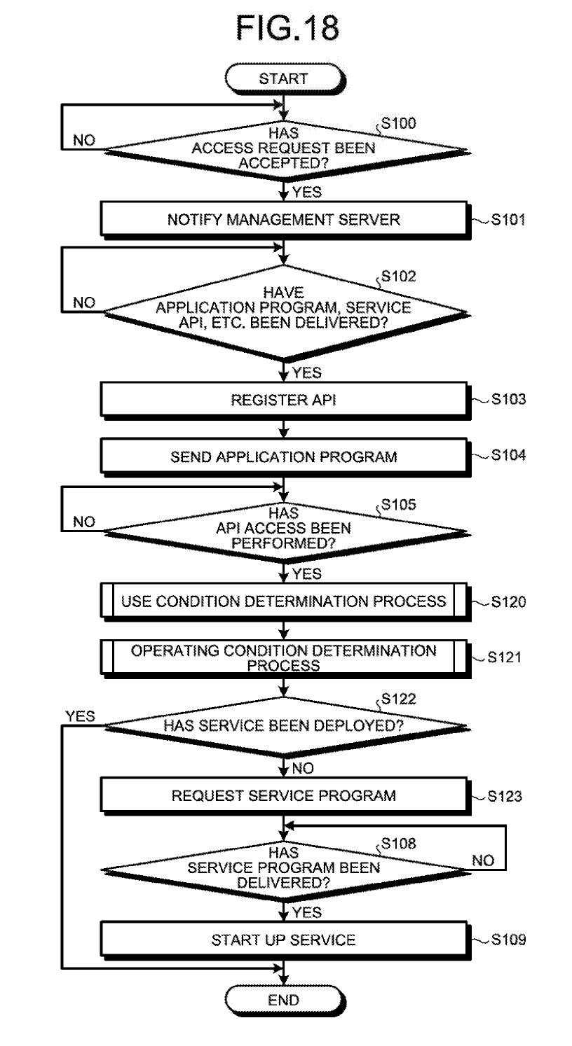

In the following, the flow of a control process in which the place server 12 according to the third embodiment controls the deployment of the service will be described. FIG. 18 is a flowchart illustrating an example of the flow of the control process performed by a place server. A part of the flow of the process illustrated in FIG. 18 is the same as a part of that illustrated in FIG. 8; therefore, steps at each of which the same process is performed are assigned the same reference numerals and only the parts that differ will mainly be described.

As illustrated in FIG. 18, if the API is called (Yes at Step S105), the acquiring unit 71 performs the use condition determination process that determines whether the service of the called API satisfies the use condition of the subject service (Step S120). The use condition determination process in detail will be described later.

Regarding the service targeted for the deployment specified by the use condition determination process, the acquiring unit 71 performs the operating condition determination process of determining whether the place server 12 satisfies the operating condition of the subject service (Step S121). The operating condition determination process in detail will be described later.

The acquiring unit 71 determines, from the operating condition determination process, whether the program of the service that satisfies the operating condition, whose deployment destination is the place server 12, and that is targeted for the deployment has been deployed (Step S122). If the deployment has been performed (Yes at Step S122), the acquiring unit 71 ends the process.

In contrast, the deployment has not been performed (No at Step S122), the acquiring unit 71 designates the repository location on the management server 11 side of the program of the service targeted for the deployment and requests the program of the service from the management server 11 (Step S123).

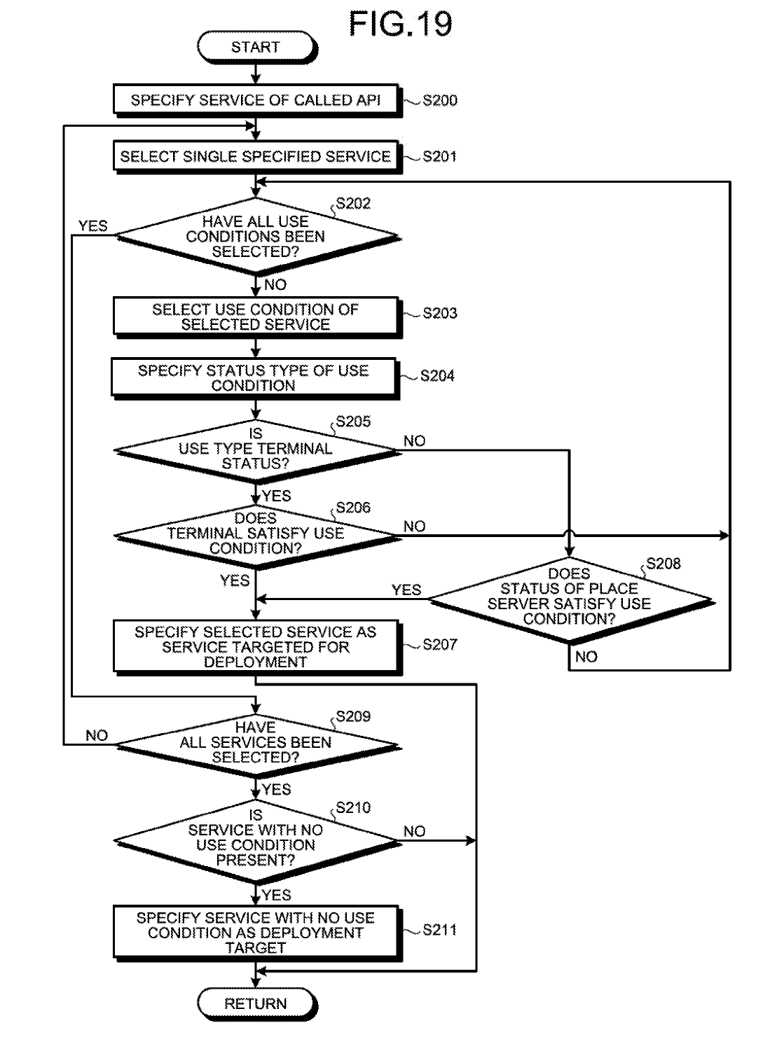

In the following, the flow of a use condition determination process will be described. FIG. 19 is a flowchart illustrating an example of the flow of the use condition determination process performed by the place server. This use condition determination process is performed from Step S120 in the use condition determination process performed by the place server 12.

As illustrated in FIG. 19, the acquiring unit 71 specifies, by using the delivery information 60, the service of the called API (Step S200). For example, if the delivery information 60 is in the state illustrated in FIG. 16 and the API of “http://drillXXX” is called, the acquiring unit 71 specifies two services associated with the API “http://drillXXX”. The acquiring unit 71 selects a single service that has not been selected between the specified services (Step S201). The acquiring unit 71 determines whether all of the use conditions of the selected service have been selected (Step S202). Furthermore, if no use condition is present in the selected service, the acquiring unit 71 determines that all of the use conditions have been selected.

If not all of the use conditions are selected (No at Step S202), the acquiring unit 71 selects a single unselected use condition between the use conditions of the selected service (Step S203). The acquiring unit 71 specifies the status type of the selected use condition on the basis of the status type information 33 (Step S204). The acquiring unit 71 determines whether the specified status type is the terminal status (Step S205). If the status type is the terminal status (Yes at Step S205), the acquiring unit 71 determines whether the status notified by the terminal device 13 that has called the API satisfies the use condition of the service (Step S206). For example, in the example illustrated in FIG. 13, it is assumed that, regarding the national language teaching material service, the use condition is the “class 1”. If the “class 1” is notified, as the status, from the terminal device 13 that has called the API of the national language teaching material service, the acquiring unit 71 determines that the use condition is satisfied.

If the use condition is satisfied (Yes at Step S206), the acquiring unit 71 specifies the selected service as the service targeted for the deployment (Step S207) and moves to the process performed by the call source.

In contrast, if the use condition is not satisfied (No at Step S206), the process moves to Step S202 described above.

In contrast, if the status type is not the terminal status (No at Step S205), the status type is the place server status. The acquiring unit 71 determines whether the status of the place server 12 satisfies the use condition of the service (Step S208). If the use condition is satisfied (Yes at Step S208), the process moves to Step S207 described above and specifies the selected service as the service targeted for the deployment. For example, in the example illustrated in FIG. 13, regarding the projector service, the use condition is a “teacher terminal connection”. If the place server 12 receives a notification of an access request including the status indicating that the type of the user is a teacher from the terminal device 13 that is used by the teacher, the place server 12 can recognize the status in which the terminal device 13 used by the teacher is being connected. If the terminal device 13 used by the teacher is being connected to the place server 12 in which the API of the projector service is called, the acquiring unit 71 determines that the use condition is satisfied.

In contrast, if the use condition is not satisfied (No at Step S208), the process moves to Step S202 described above.

In contrast, if all of the use conditions have been selected (Yes at Step S202), the acquiring unit 71 determines whether all of the specified service have been selected (Step S209). If not all of the specified services have been selected (No at Step S209), the process moves to Step S201 described above.

In contrast, if all of the specified services have been selected (Yes at Step S209), the acquiring unit 71 determines whether the service with no use condition is present in the specified services (Step S210). If the service with no use condition is present (Yes at Step S210), the acquiring unit 71 specifies the service with no use condition as the service targeted for the deployment (Step S211) and moves to the process of call source.

In contrast, if a service with no use condition is not present (No at Step S210), the process moves to the process of the call source.

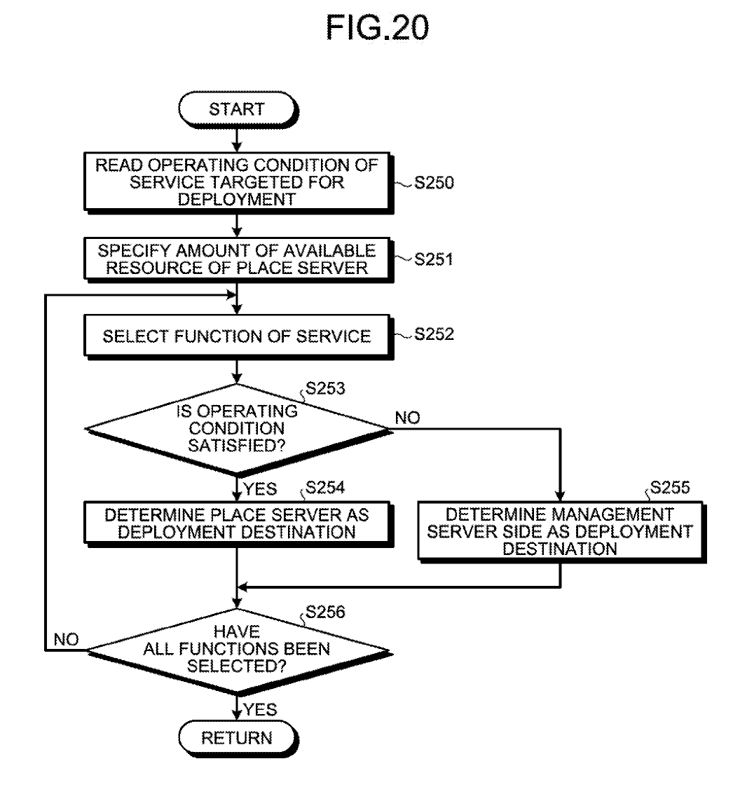

In the following, the flow of an operating condition determination process will be described. FIG. 20 is a flowchart illustrating an example of the flow of the operating condition determination process performed by the place server. This operating condition determination process is performed from Step S121 in the operating condition determination process performed by the place server 12.

As illustrated in FIG. 20, the acquiring unit 71 reads the operating condition of the service targeted for the deployment from the delivery information 60 (Step S250). The acquiring unit 71 specifies the amount of the resource that can be used by the place server 12 (Step S251). If the service targeted for the deployment can be arranged, in a distributed manner, in different servers for each function, the acquiring unit 71 selects a single unselected function from among the functions of the services targeted for the deployment (Step S252). Furthermore, if the service targeted for the deployment is not able to be arranged in different servers in a distributed manner, the acquiring unit 71 selects the service targeted for the deployment by recognizing all of the services targeted for the deployment as a single function.

The acquiring unit 71 determines whether the amount of resource that can be used by the place server 12 satisfies the operating condition of the selected function of the service that is targeted for the deployment (Step S253). If the operating condition is satisfied (Yes at Step S253), the acquiring unit 71 determines that the deployment destination of the program of the selected function of the service that is targeted for the deployment to the place server 12 (Step S254).

In contrast, if the operating condition is not satisfied (No at Step S253), the acquiring unit 71 determines that the deployment destination of the program of the selected function of the service that is targeted for the deployment to the management server 11 (Step S255).

The acquiring unit 71 determines whether all of the functions of the services targeted for the deployment have been selected (Step S256). If not all of the functions have been selected (No at Step S256), the process moves to Step S252 described above.

In contrast, if all of the functions have been selected (Yes at Step S256), the process moves to the process of the call source.

Here, for example, it is assumed that the amount of the resource that can be used in the place server 12 is the memory of 1 [GB], the CPU usage of 1000 [req/s], the storage equal to or less than 512 [GBs], and the IO usage of 256 [MB/s]. In this case, for example, it is specified that the deployment destination of the document sharing service illustrated in FIG. 13 is the place server 12. Furthermore, it is specified that the deployment destination of the AP server of the image editing service is the place server 12. Furthermore, it is specified that the deployment destination of the DB server of the image editing service is the management server 11.

Effects

The management server 11 according to the embodiment further delivers the operating condition of the service together with the definition information. If the place server 12 satisfies the operating condition that is acquired together with the definition information, the place server 12 acquires the program of the service defined in the definition information. Consequently, if the place server 12 satisfies the operating condition of the service, the service can be deployed. Furthermore, for example, if a load of the place server 12 is high and sufficient performance is not able to be obtained, it is possible to restrain the service from being deployed to the place server 12.

Furthermore, if the place server 12 does not satisfy the operating condition, the place server 12 according to the embodiment transfers the call of the service from the terminal device 13 to the management server 11. The management server 11 provides the service due to the program of the service that is transferred from the place server 12 and that is called. Consequently, for example, if a load of the place server 12 is high and sufficient performance is not able to be obtained, it is possible to allow the service to be performed in the management server 11.

Furthermore, the management server 11 according to the embodiment delivers the operating condition for each function of the service that can be arranged in different servers in a distributed manner. The place server 12 acquires the program of the service that constitutes the functions of the services in which the place server 12 satisfies the operating condition. Consequently, the function that satisfies the operating condition can be performed by the place server 12 for each function of the service. Furthermore, for example, it is possible to restrain the function of the service from which sufficient performance is obtained due to a high load of the place server 12 from being deployed to the place server 12.

### [d] Fourth Embodiment

In the above explanation, a description has been given of the embodiment of the device disclosed in the present invention; however, the present invention can be implemented with various kinds of embodiments other than the embodiment described above. Therefore, another embodiment included in the present invention will be described below.

For example, in the third embodiment described above, an example has been described of a case in which it is determined whether the place server 12 satisfies the operating condition or the use condition of the service in the timing in which the place server 12 receives a call of the API of the service from the terminal device 13; however, the disclosed device is not limited to this. For example, if the disclosed device is used in the second embodiment and if the API of the service is delivered from the management server 11, it is determined whether the place server 12 satisfies the operating condition or the use condition of the delivered service. Then, if the place server 12 satisfies the operating condition or the use condition, the place server 12 may also acquire the program of the service in the background without waiting for a call of the API of the service.

Furthermore, in the first to the third embodiments described above, an example has been described of a case in which the management server 11 delivers the program of the service in accordance with a request from the place server 12; however, the disclosed device is not limited to this. For example, if the management server 11 receives a notification of the status from the place server 12, the management server 11 may also deliver both the program of the application and the program of the service used by the subject application in accordance with the status to the place server 12.

Furthermore, in the embodiments described above, an example has been described of a case of sending a check-in request that includes therein the current location of the terminal device 13 or a user of the terminal device 13 as the status; however, the disclosed device is not limited to this. For example, the terminal device 13 notifies the place server 12 of the current time, the time zone of working hours, and the time zone of a time table as a status. The place server 12 may also acquire, from the management server 11, application and the service in accordance with the notified time status. Consequently, for example, the place server 12 and the terminal device 13 can change available application and the service in accordance with the time zone between the working time and the break time and the time zone of the time table.

Furthermore, in the embodiment described above, an example has been described of a case in which, if the service has been deployed, the place server 12 does not acquire the program of the service from the management server 11; however, the disclosed device is not limited to this. For example, if the API of the service is called from the terminal device 13, even if the service of the API has already been deployed, the place server 12 may also acquire the program of the latest version of the service from the management server 11. Furthermore, the place server 12 makes an inquiry about the presence/absence of an update of the program of the service to the management server 11 and, if an update of the deployed service program is present, the place server 12 may also acquire the program of the latest version of the service from the management server 11. Furthermore, even if the service has been deployed, the place server 12 may also acquire the program of the latest version of the service from the management server 11 at constant intervals or in a predetermined timing.

Furthermore, in the embodiment described above, an example has been described of a case in which the place server 12 deletes the program of the service that satisfies a predetermined deletion condition and deletes the API of the subject service; however, the disclosed device is not limited to this. For example, the place server 12 may also leave the API of the service without deleting the API and may also acquire the program of the service when the API of the service is called. By leaving the API of the service, the place server 12 can prevent an error in the API when the API of the service is called from the terminal device 13.

Furthermore, in the embodiment described above, an example has been described of a case in which the operating condition or the use condition is set to the amount of the hardware resource; however, the disclosed device is not limited to this. For example, as the operating condition or the use condition, the condition of the transmission speed between the place server 12 and the terminal device 13 may also be set and, if a transmission speed does not satisfy the condition, the service may also be deployed to the management server 11.

Furthermore, the components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, each of the processing units of the delivery unit 40 and the service providing unit 41 in the management server 11 may also appropriately be integrated. Furthermore, each of the processing units of the accepting unit 70, the acquiring unit 71, the sending unit 72, the service providing unit 73, the deleting unit 74, and the transferring unit 75 in the place server 12 may also appropriately be integrated. Furthermore, all or any part of the processing functions performed by each of the processing units of the processes performed by the processing units of the management server 11 and the place server 12 can be implemented by a CPU and by programs analyzed and executed by the CPU or implemented as hardware by wired logic.

Service Deployment Program

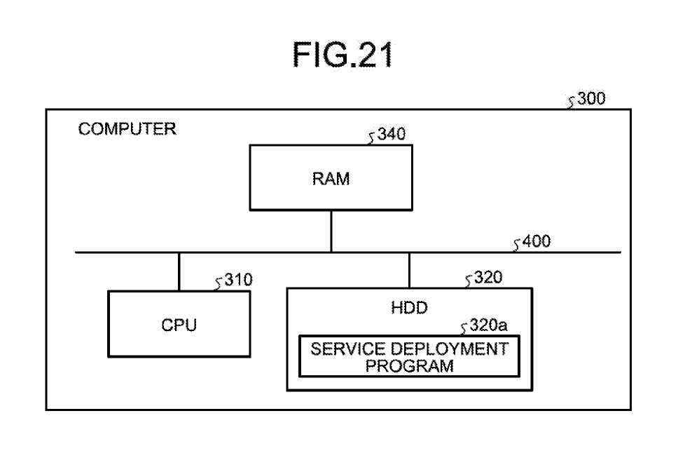

Furthermore, various kinds of processes described in the above embodiments can be implemented by executing programs prepared in advance in a computer system, such as a personal computer, a workstation, or the like. Accordingly, in the following, a description will be given of an example of a computer system that executes a program having the same function as that performed in the embodiments described above. FIG. 21 is a block diagram illustrating a computer that executes a service deployment program.

As illustrated in FIG. 21, a computer 300 includes a CPU 310, a hard disk drive (HDD) 320, and a random access memory (RAM) 340. Each of the units 310 to 340 are connected via a bus 400.

The HDD 320 stores therein, in advance, a service deployment program 320a having the same function as that of each of the processing units according to the embodiments described above. For example, the HDD 320 stores therein stores therein the service deployment program 320a having the same function as that of each of the accepting unit 70, the acquiring unit 71, the sending unit 72, the service providing unit 73, the deleting unit 74, and the transferring unit 75 in the place server 12 according to the embodiments described above. Furthermore, the service deployment program 320a may also appropriately be separated.

Furthermore, the HDD 320 stores therein various kinds of data. For example, the HDD 320 stores therein an OS or various kinds of data.

Then, the CPU 310 reads the service deployment program 320a from the HDD 320 and executes the service deployment program 320a, whereby the CPU 310 executes the same operation as that executed by each of the processing units according to the embodiments. Namely, the service deployment program 320a executes the same operation as that executed by the accepting unit 70, the acquiring unit 71, the sending unit 72, the service providing unit 73, the deleting unit 74, and the transferring unit 75 according to the embodiments.

Furthermore, the service deployment program 320a described above does not need to be stored in the HDD 320 from the beginning. For example, the program is stored in a “portable physical medium”, such as a flexible disk (FD), a compact disk read only memory (CD-ROM), a digital versatile disk (DVD disk), a magneto-optic disk, an IC card, or the like, that is to be inserted into the computer 300. Then, the computer 300 may also read and execute the program from the portable physical medium.

Furthermore, the programs may also be stored in “other computers (servers)” or the like connected to the computer 300 via a public circuit, the Internet, a LAN, a WAN, or the like. Then, the computer 300 may also read and execute the program from the other computers.

According to an aspect of an embodiment of the present invention, an advantage is provided in that a service can appropriately be deployed in accordance with a status.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a first server device; and
a second server device, wherein
the first server device includes
a storage unit that stores therein a first program that is a program of an application that is used in a terminal device and a second program that is a program of a service that is used by the application, and
a delivery unit that delivers the first program and the second program that are in accordance with a status notified from the second server device, and
the second server device includes
an accepting unit that accepts an access request from the terminal device,
an acquiring unit that notifies, in accordance with the access request accepted by the accepting unit, the first server device of the status of the terminal device and that acquires the first program and the second program,
a sending unit that sends the first program acquired by the acquiring unit to the terminal device, and
a providing unit that provides the service due to the second program acquired by the acquiring unit.

2. The information processing system according to claim 1, wherein
when the acquiring unit accepts the access request from the terminal device, the acquiring unit acquires the first program and definition information that defines the service that is used by the application of the first program, and
when the service defined in the acquired definition information is called, the acquiring unit acquires the second program that is the program of the service defined in the definition information.

3. The information processing system according to claim 1, wherein, when the acquiring unit accepts the access request from the terminal device, the acquiring unit acquires the first program and definition information that defines the service that is used by the application of the first program and subsequently acquires the second program that is the program of the service defined in the acquired definition information.

4. The information processing system according to claim 2, wherein
the delivery unit further delivers an operating condition of the service together with the definition information, and
when the second server device satisfies the operating condition that is acquired together with the definition information, the acquiring unit acquires the second program that is the program of the service defined in the definition information.

5. The information processing system according to claim 4, wherein
the second server device further includes a transferring unit that transfers, when the second server device does not satisfy the operating condition, a call of the service received from the terminal device to the first server device, and
the first server device further includes a second providing unit that provides the service due to the program of the called service that is transferred from the second server device.

6. The information processing system according to claim 4, wherein
the delivery unit delivers the operating condition for each of functions of the services that can be distributed to different servers, and
the acquiring unit acquires the second program that is the program of the services constituting the functions of the services in which the second server device satisfies the operating condition.

7. An information processing apparatus comprising:
an accepting unit that accepts an access request from a terminal device;
an acquiring unit that notifies a server device of a status of the terminal device in accordance with the access request and that acquires, from the server device, a first program that is a program of an application that is used in the terminal device and a second program that is a program of a service that is used by the application;
a sending unit that sends, to the terminal device, the first program delivered from the server device; and
a providing unit that provides the service due to the second program delivered from the server device.

8. A service deployment method of delivering a service performed by a first server device and a second server device, the service deployment method comprising:
notifying, performed by the second server device when the second server device accepts an access request from a terminal device, the first server device of a status of the terminal device in accordance with the access request;
storing, performed by the first server device, a first program that is a program of an application that is used in the a terminal device and a second program that is a program of the service that is used by the application;
delivering, performed by the first server device, the first program and the second program that are in accordance with the status notified from the second server device; and
sending, performed by the second server device, the first program delivered from the first server device to the terminal device and providing, performed by the second server device, the service due to the second program delivered from the first server device.
